(19) United States
(12) Patent Application Publication
(10) Pub. No.: US 2026/0177784 A1
(43) Pub. Date: Jun. 25, 2026

(54) IMAGING OPTICAL LENS

(71) Applicant: AAC OPTICS (CHANGZHOU) CO., LTD., Changzhou City (CN)

(72) Inventor: Hongxiang Pan, Changzhou (CN)

(21) Appl. No.: 19/292,970

(22) Filed: Aug. 7, 2025

Related U.S. Application Data
(63) Continuation of application No. PCT/CN2024/140831, filed on Dec. 20, 2024.

(51) Int. Cl. G02B 13/00; G02B 1/04; G02B 9/64

(52) U.S. Cl. CPC G02B 13/0045; G02B 1/041; G02B 9/64

(57) ABSTRACT

Disclosed is an imaging optical lens. The imaging optical lens includes seven lenses sequentially arranged from an object-side to an image-side as follows: a first lens, a second lens, a third lens, a fourth lens, a fifth lens, a sixth lens, and a seventh lens. The focal length of the imaging optical lens is f, the focal length of the seventh lens is f7, the field of view of the 1.0 field of view of the imaging optical lens is FOV, the full field-of-view (1.0H) image-height of the imaging optical lens is IH, the central curvature radius of the object-side surface of the sixth lens is R11, and the central curvature radius of the image-side surface of the sixth lens is R12. The following relationships are satisfied: 3.95≤f7/f≤6.00; 100.00≤(FOV*f)/IH≤120.00; 3.50≤(R11+R12)/(R11−R12)≤70.00. The imaging optical lens has excellent optical performance while meeting the design requirements of a large aperture and ultra-wide angle.

### TECHNICAL FIELD

Embodiments of the present disclosure relate to the technical field of optical lenses, and in particular to an imaging optical lens suitable for portable terminal devices such as action cameras, mobile phones, digital cameras, and camera devices such as monitors and PC lenses.

### BACKGROUND

In recent years, with the proliferation of smart mobile phones, the demand for miniaturized photographic lenses has grown steadily. Typically, the photosensitive components in conventional photographic lenses are Charge-Coupled Devices (CCDs) or Complementary Metal-Oxide Semiconductor (CMOS) sensors. Advances in semiconductor manufacturing processes have enabled the scaling down of pixel dimensions; concurrently, the industry trend toward electronic products with enhanced functionality and compact, lightweight form factors has further amplified this demand. Consequently, miniaturized imaging lenses with superior imaging performance have become mainstream in the current market.

To achieve better imaging quality, traditional lenses mounted on mobile phone cameras typically employ configurations with three, four, five, or even six lenses. However, as technology advances and user demands diversify, the pixel areas of photosensitive devices continue to shrink, and system requirements for imaging quality escalate, a seven-lens structure has gradually emerged in lens designs. While conventional seven-lens systems already exhibit favorable optical performance, the configurations of these lenses regarding optical power, inter-lens spacing, and lens geometry remain suboptimal. As a result, such lenses are unable to meet design specifications for large apertures and ultra-wide angles despite maintaining excellent optical performance.

### SUMMARY

The embodiments of the present disclosure are intended to provide an imaging optical lens that meets the design requirements of a large aperture and ultra-wide angle while having excellent optical performance.

In order to solve the above technical problems, the embodiments of the present disclosure provide an imaging optical lens. The imaging optical lens includes seven lenses that are sequentially arranged from the object-side to the image-side as follows:
a first lens with negative refractive power;
a second lens with positive refractive power;
a third lens with positive refractive power;
a fourth lens with positive refractive power;
a fifth lens with negative refractive power;
a sixth lens with refractive power; and
a seventh lens with positive refractive power;
f represents a focal length of the imaging optical lens;
f7 represents a focal length of the seven lens;
FOV represents the field of view angle of the 1.0 field of view of the imaging optical lens;
IH represents a full field-of-view (1.0H) image-height;
R11 represents a central curvature radius of the object-side surface of the sixth lens;
R12 represents a central curvature radius of the image-side surface of the sixth lens;
and the imaging optical lens satisfies the following relationships:

$$3.95 \leq f 7 / f \leq 6. ;$$

$$100. \leq ( FOV * f ) / IH \leq 120. ;$$

$$3.5 \leq ( R 11 + R 12 ) / ( R 11 - R 12 ) \leq 70. .$$

In some embodiments, a refractive index of the first lens is n1, and the imaging optical lens satisfies the following relationship: 1.70≤n1≤2.10.

In some embodiments, BF represents an on-axis distance from the image-side surface of the seventh lens to the image surface, TTL represents a total optical length of the imaging optical lens, and the imaging optical lens satisfies the following relationship:

$$0.1 \leq BF / TTL \leq 0.25 .$$

In some embodiments, d3 represents an on-axis thickness of the second lens, d5 represents an on-axis thickness of the third lens, and the imaging optical lens satisfies the following relationship: 1.40≤d3/d5≤3.00.

In some embodiments, an object-side surface of the first lens is convex in a paraxial region, and an image-side surface of the first lens is concave in a paraxial region; f1 represents a focal length of the first lens, R1 represents a central curvature radius of the object-side surface of the first lens, R2 represents a central curvature radius of the image-side surface of the first lens, d1 represents an on-axis thickness of the first lens, and the imaging optical lens satisfies the following relationships:

$$- 1.5 \leq f 1 / f \leq - 1.1 ;$$

$$1.1 \leq ( R 1 + R 2 ) / ( R 1 - R 2 ) \leq 1.35 ;$$

$$0.03 \leq d 1 / TTL \leq 0.17 .$$

In some embodiments, an object-side surface of the second lens is concave in a paraxial region, and an image-side surface of the second lens is convex in a paraxial region; f2 represents a focal length of the second lens, R3 represents a central curvature radius of the object-side surface of the second lens, R4 represents a central curvature radius of the image-side surface of the second lens, d3 represents an on-axis thickness of the second lens, and the imaging optical lens satisfies the following relationships:

$$5.6 \leq f 2 / f \leq 7.8 ;$$

$$0.99 \leq ( R 3 + R 4 ) / ( R 3 - R 4 ) \leq 1.33 ;$$

$$0.15 \leq d 3 / TTL \leq 0.24 .$$

In some embodiments, an object-side surface of the third lens is convex in a paraxial region, and an image-side surface of the third lens is convex in a paraxial region; f3 represents a focal length of the third lens, R5 represents a central curvature radius of the object-side surface of the third lens, R6 represents a central curvature radius of the image-side surface of the third lens, d5 represents an on-axis thickness of the third lens, and the imaging optical lens satisfies the following relationships:

$$1.52 \leq f 3 / f \leq 1.8 ;$$

$$- 0.21 \leq ( R 5 + R 6 ) / ( R 5 - R 6 ) \leq - 0.17 ;$$

$$0.06 \leq d 5 / TTL \leq 0.13 .$$

In some embodiments, an object-side surface of the fourth lens is convex in a paraxial region, an image-side surface of the fourth lens is convex in a paraxial region; f4 represents a focal length of the fourth lens, R7 represents a central curvature radius of the object-side surface of the fourth lens, R8 represents a central curvature radius of the image-side surface of the fourth lens, d7 represents an on-axis thickness of the fourth lens, and the imaging optical lens satisfies the following relationships:

$$1.7 \leq f 4 / f \leq 1.96 ;$$

$$- 0.85 \leq ( R 7 + R 8 ) / ( R 7 - R 8 ) \leq - 0.5 ;$$

$$0.04 \leq d 7 / TTL \leq 0.06 .$$

In some embodiments, an object-side surface of the fifth lens is concave in a paraxial region, and an image-side surface of the fifth lens is concave in a paraxial region; f5 represents a focal length of the fifth lens, R9 represents a central curvature radius of the object-side surface of the fifth lens, R10 represents a central curvature radius of the image-side surface of the fifth lens, d9 represents an on-axis thickness of the fifth lens, and the imaging optical lens satisfies the following relationships:

$$- 1.6 \leq f 5 / f \leq - 1.4 ;$$

$$0.2 \leq ( R 9 + R 10 ) / ( R 9 - R 10 ) \leq 0.42 ;$$

$$0.02 \leq d 9 / TTL \leq 0.04 .$$

In some embodiments, an object-side surface of the sixth lens is convex in a paraxial region, and an image-side surface of the sixth lens is concave in a paraxial region; f6 represents a focal length of the sixth lens; d11 represents an on-axis thickness of the sixth lens, and the imaging optical lens satisfies the following relationship:

$$- 13.5 \leq f 6 / f \leq 72. ;$$

$$0.02 \leq d 11 / TTL \leq 0.05 .$$

In some embodiments, an object-side surface of the seventh lens is convex in a paraxial region, and an image-side surface of the seventh lens is concave in a paraxial region; R13 represents a central curvature radius of the object-side surface of the seventh lens, R14 represents central curvature radius of the image-side surface of the seventh lens, d13 represents an on-axis thickness of the seventh lens, and the imaging optical lens satisfies the following relationship:

$$- 3.8 \leq ( R 13 + R 14 ) / ( R 13 - R 14 ) \leq - 2.2 ;$$

$$0.02 \leq d 13 / TTL \leq 0.09 .$$

In some embodiments, the first lens, the third lens, and the seventh lens are made of glass; the second lens, the fourth lens, the fifth lens, and the sixth lens are made of plastic.

In an embodiment, the f-number (FNO) of the imaging optical lens is less than or equal to 2.30; the Field of view angle (FOV) of the 1.0 field of view of the imaging optical lens is greater than or equal to 154.67°.

The beneficial effects of the embodiments of the present disclosure are as follows: the imaging optical lens according to the present disclosure has the characteristics of a large aperture and ultra-wide angle, with excellent optical performance, and is particularly suitable for mobile phone camera lens modules and WEB camera lenses equipped with high-pixel CCD, CMOS, and other imaging elements.

### BRIEF DESCRIPTION OF THE DRAWINGS

To more clearly illustrate the technical solutions in the embodiments of the present disclosure, the following will briefly introduce the drawings required in the description of the embodiments. Obviously, the drawings in the following description are only some embodiments of the present disclosure. For those of ordinary skill in the art, other drawings can also be obtained from these drawings without creative efforts.

FIG. 1 is a schematic structural diagram of an imaging optical lens in a first embodiment of the present disclosure.

FIG. 2 is a schematic diagram of the lateral color of the imaging optical lens shown in FIG. 1.

FIG. 3 is a schematic diagram of the longitudinal aberration of the imaging optical lens shown in FIG. 1.

FIG. 4 is a schematic diagram of the field curvature and distortion of the imaging optical lens shown in FIG. 1.

FIG. 5 is a schematic structural diagram of an imaging optical lens in a second embodiment of the present disclosure.

FIG. 6 is a schematic diagram of the lateral color of the imaging optical lens shown in FIG. 5.

FIG. 7 is a schematic diagram of the longitudinal aberration of the imaging optical lens shown in FIG. 5.

FIG. 8 is a schematic diagram of the field curvature and distortion of the imaging optical lens shown in FIG. 5.

FIG. 9 is a schematic structural diagram of an imaging optical lens in a third embodiment of the present disclosure.

FIG. 10 is a schematic diagram of the lateral color of the imaging optical lens shown in FIG. 9.

FIG. 11 is a schematic diagram of the longitudinal aberration of the imaging optical lens shown in FIG. 9.

FIG. 12 is a schematic diagram of the field curvature and distortion of the imaging optical lens shown in FIG. 9.

FIG. 13 is a schematic structural diagram of an imaging optical lens in a fourth embodiment of the present disclosure.

FIG. 14 is a schematic diagram of the lateral color of the imaging optical lens shown in FIG. 13.

FIG. 15 is a schematic diagram of the longitudinal aberration of the imaging optical lens shown in FIG. 13.

FIG. 16 is a schematic diagram of the field curvature and distortion of the imaging optical lens shown in FIG. 13.

FIG. 17 is a schematic structural diagram of an imaging optical lens in a fifth embodiment of the present disclosure.

FIG. 18 is a schematic diagram of the lateral color of the imaging optical lens shown in FIG. 17.

FIG. 19 is a schematic diagram of the longitudinal aberration of the imaging optical lens shown in FIG. 17.

FIG. 20 is a schematic diagram of field curvature and distortion of the imaging optical lens shown in FIG. 17.

FIG. 21 is a schematic structural diagram of an imaging optical lens in a sixth embodiment of the present disclosure.

FIG. 22 is a schematic diagram of the lateral color of the imaging optical lens shown in FIG. 21.

FIG. 23 is a schematic diagram of the longitudinal aberration of the imaging optical lens shown in FIG. 21.

FIG. 24 is a schematic diagram of field curvature and distortion of the imaging optical lens shown in FIG. 21.

FIG. 25 is a schematic structural diagram of an imaging optical lens according to a seventh embodiment of the present disclosure.

FIG. 26 is a schematic diagram of the lateral color of the imaging optical lens shown in FIG. 25.

FIG. 27 is a schematic diagram of the longitudinal aberration of the imaging optical lens shown in FIG. 25.

FIG. 28 is a schematic diagram of field curvature and distortion of the imaging optical lens shown in FIG. 25.

FIG. 29 is a schematic structural diagram of the imaging optical lens of the comparative embodiment.

FIG. 30 is a schematic diagram of the lateral color of the imaging optical lens shown in FIG. 29.

FIG. 31 is a schematic diagram of the longitudinal aberration of the imaging optical lens shown in FIG. 29.

FIG. 32 is a schematic diagram of field curvature and distortion of the imaging optical lens shown in FIG. 29.

### DETAILED DESCRIPTION OF THE EMBODIMENTS

The following will be described in detail with reference to the accompanying drawings to illustrate the purpose, technical solutions and advantages of the embodiments of the present disclosure. However, those skilled in the art should appreciate that many technical details are proposed in the various embodiments of the present disclosure in order to enable the reader to better understand the present disclosure. However, the technical solutions claimed in the present disclosure can be implemented even without these technical details and various changes and modifications based on the following embodiments.

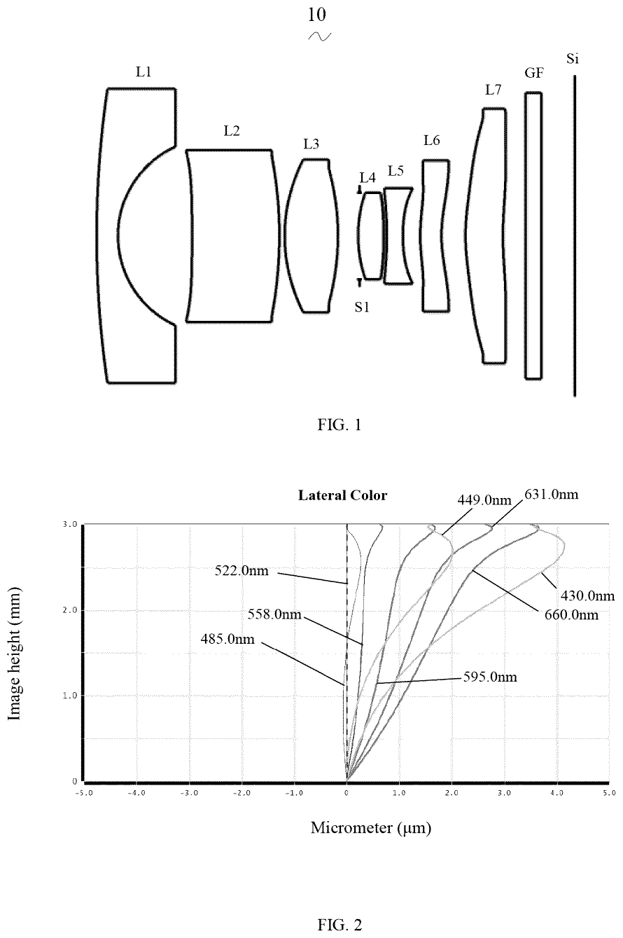

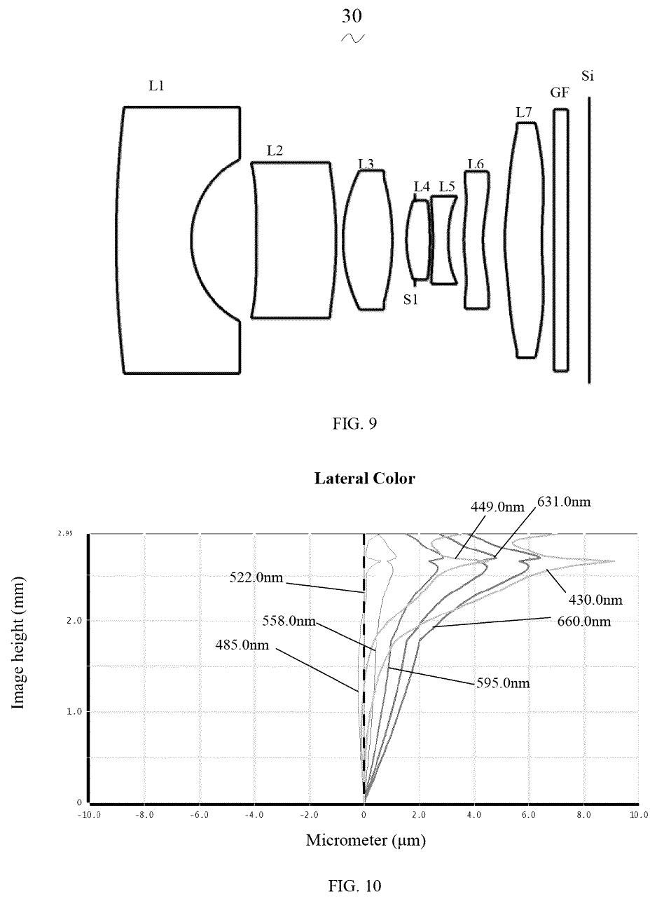

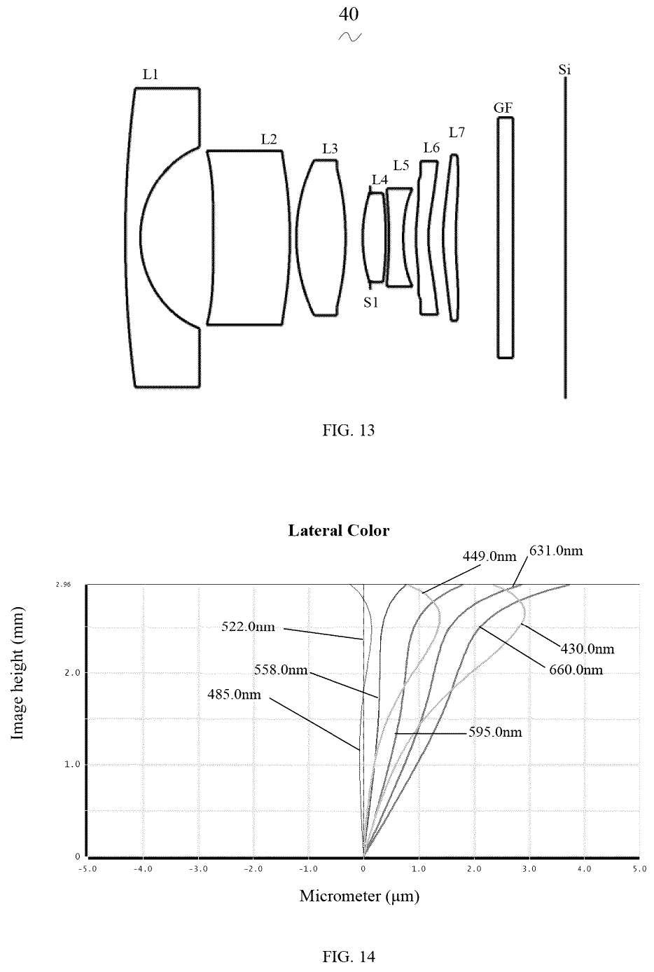

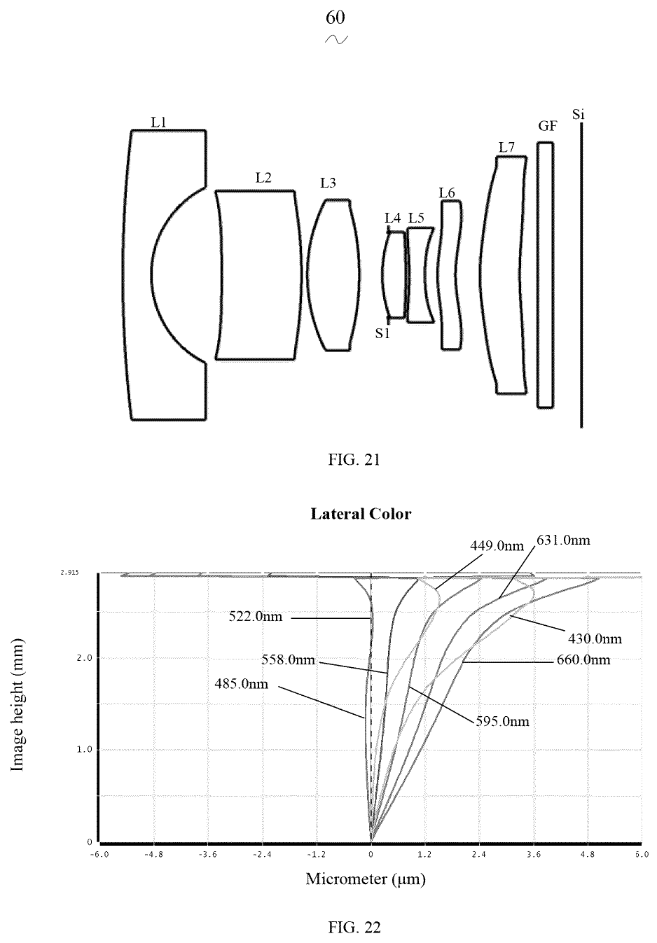

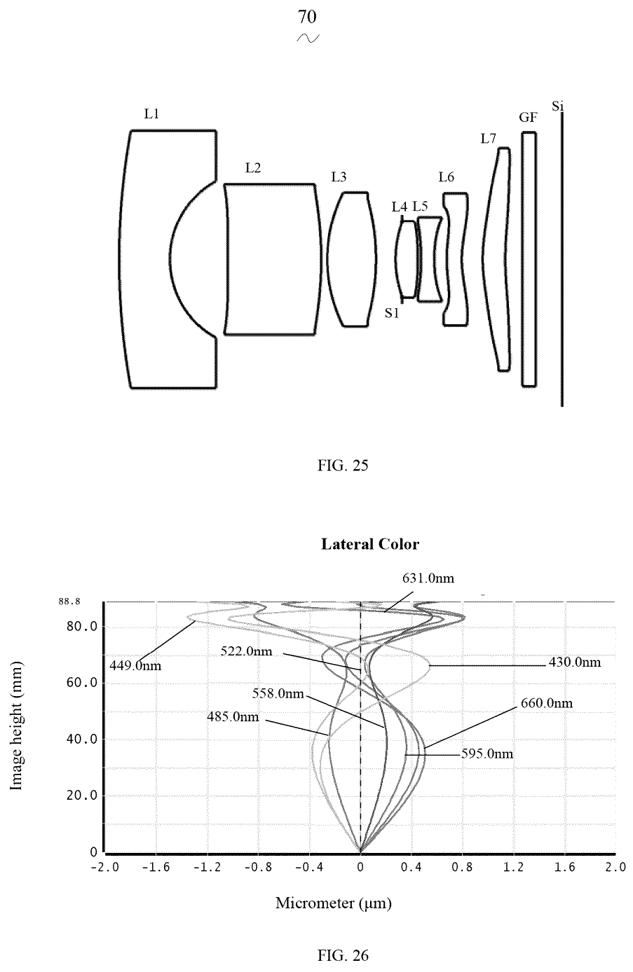

Referring to FIG. 1, FIG. 5, FIG. 9, FIG. 13, FIG. 17, FIG. 21, and FIG. 25, the technical solution of the present disclosure provides imaging optical lenses 10, 20, 30, 40, 50, 60 and 70. The imaging optical lenses 10, 20, 30, 40, 50, 60, and 70 each include seven lenses. For example, the imaging optical lens includes, sequentially from the object side to the image side: a first lens L1, a second lens L2, a third lens L3, an aperture S1, a fourth lens L4, a fifth lens L5, a sixth lens L6, and a seventh lens L7. One or more optical elements, such as an optical filter (filter) GF, may be arranged between the seventh lens L7 and the image surface Si.

For example, the seven lenses are sequentially arranged from the object side to the image side as follows: a first lens L1 with negative refractive power, a second lens L2 with positive refractive power, a third lens L3 with positive refractive power, a fourth lens L4 with positive refractive power, a fifth lens L5 with negative refractive power, a sixth lens L6 with positive or negative refractive power, and a seventh lens L7 with positive refractive power.

A focal length of the imaging optical lens 10, 20, 30, 40, 50, 60, and 70 is defined as f, and the focal length of the seventh lens L7 is defined as f7. The following relationship formula should be satisfied: 3.95≤f7/f≤6.00. Within this range, the focal length of the last lens can be controlled, which helps collect light and ensure the amount of light transmitted.

A field of view angle of the 1.0 field of view of the imaging optical lens 10, 20, 30, 40, 50, 60, and 70 is defined as FOV, and the full field-of-view (1.0H) image-height is defined as IH. The following relationship formula should be satisfied: 100.00≤(FOV*f)/IH≤120.00. Within this range, the imaging optical lens can balance a large field of view angle and a long focal length, achieving the effect of medium-distance imaging.

A central curvature radius of the object-side surface of the sixth lens L6 is defined as R11, and the central curvature radius of the image-side surface of the sixth lens L6 is defined as R12. The following relationship formula should be satisfied: 3.50≤(R11+R12)/(R11−R12)≤70.00. It specifies the shape of the sixth lens L6. Within this range, the deflection degree of light passing through the lens can be reduced, chromatic aberration can be effectively corrected, and the chromatic aberration |LC| can be controlled to satisfy |LC|≤10.0 μm.

When the above relationships are satisfied, the imaging optical lenses 10, 20, 30, 40, 50, 60, and 70 exhibit excellent optical performance and meet the design requirements of a large aperture, ultra-wide angle, and ultra-thinness. According to the characteristics of the imaging optical lenses 10, 20, 30, 40, 50, 60, and 70, the imaging optical lenses 10, 20, 30, 40, 50, 60, and 70 are particularly suitable for action cameras, mobile phone camera lens modules, and WEB camera lenses equipped with high-pixel CCD, CMOS, and other imaging elements.

Based on the above relationships and their achievable functions, the characteristics of each lens are further detailed as follows.

The refractive index of the first lens L1 is defined as n1, and the following relationship formula should be satisfied: 1.70≤n1≤2.10. The first lens L1 preferably adopts a high refractive index material, which helps reduce the front port diameter and improve imaging quality.

An on-axis distance from the image-side surface of the seventh lens L7 to the image surface is defined as BF, and the total optical length of the imaging optical lens 10, 20, 30, 40, 50, 60, and 70 is defined as TTL. The following relationship formula should be satisfied: 0.10≤BF/TTL≤0.25. While achieving miniaturization, this range ensures a sufficient back focus, facilitating module assembly. Additionally, it results in a short total length, a compact structure, reduced lens sensitivity to MTF, improved production yield, and lower production costs.

An on-axis thickness of the second lens L2 is defined as d3, and the on-axis thickness of the third lens L3 is defined as d5. The following relationship formula should be satisfied: 1.40≤d3/d5≤3.00. It specifies the ratio of the central thickness of the second lens L2 to the third lens L3, helping to compress the total length of the optical system within this range.

An object-side surface of the first lens L1 is convex in a paraxial region, and an image-side surface of the first lens L1 is concave in a paraxial region. Alternatively, the object-side surface and the image-side surface of the first lens L1 may be configured with other concave and convex distributions.

A focal length of the imaging optical lens 10, 20, 30, 40, 50, 60, and 70 is defined as f, and the focal length of the first lens L1 is defined as f1. The following relationship formula should be satisfied: −1.50≤f1/f≤−1.10. Within this range, reasonable distribution of optical power enables the system to achieve better imaging quality and lower sensitivity.

A central curvature radius of the object-side surface of the first lens L1 is R1, and a central curvature radius of the image-side surface of the first lens L1 is R2. The following relationship formula should be satisfied: 1.10≤(R1+R2)/(R1−R2)≤1.35, it specifies the shape of the first lens L1. When within the range, it helps correct aberrations at off-axis angles and other issues and is beneficial for the development of ultra-thin and wide-angle designs.

An on-axis thickness of the first lens L1 is d1, and a total optical length of the imaging optical lens 10, 20, 30, 40, 50, 60, and 70 is TTL. The following relationship formula should be satisfied: 0.03≤d1/TTL≤0.17. Within the range, it is beneficial to realize ultra-thinness.

In an embodiment, an object-side surface of the second lens L2 is concave in a paraxial region, and an image-side surface of the second lens L2 is convex in a paraxial region. The object-side surface and the image-side surface of the second lens L2 may also be configured with other concave and convex distributions.

A focal length of the imaging optical lens 10, 20, 30, 40, 50, 60, and 70 is defined as f, and the focal length of the second lens L2 is defined as f2. The following relationship formula should be satisfied: 5.60≤f2/f≤7.80. Within this range, reasonable distribution of optical power enables the system to achieve better imaging quality and lower sensitivity.

A central curvature radius of the object-side surface of the second lens L2 is R3, and a central curvature radius of the image-side surface of the second lens L2 is R4. The following relationship formula should be satisfied: 0.99≤(R3+R4)/(R3−R4)≤1.33. It specifies the shape of the second lens L2. When within the range, it helps correct off-axis aberrations and other issues, which is beneficial for developing ultra-thin and wide-angle lenses.

An on-axis thickness of the second lens L2 is d3, and the total optical length of the imaging optical lens 10, 20, 30, 40, 50, 60, and 70 is TTL. The following relationship should be satisfied: 0.15≤d3/TTL≤0.24. Within the range, it is beneficial for achieving ultra-thinness.

In an embodiment, an object-side surface of the third lens L3 is concave in a paraxial region, and the image-side surface of the third lens L3 is convex in a paraxial region. The object-side surface and the image-side surface of the third lens L3 may also be configured with other concave and convex distributions.

A focal length of the imaging optical lens 10, 20, 30, 40, 50, 60, and 70 is defined as f, and a focal length of the third lens L3 is defined as f3. The following relationship formula should be satisfied: 1.52≤f3/f≤1.80. Through the reasonable distribution of the optical power of the third lens L3, the system has better imaging quality and lower sensitivity.

A central curvature radius of the object-side surface of the third lens L3 is R5, and a central curvature radius of the image-side surface of the third lens L3 is R6. The following relationship formula should be satisfied: −0.21≤(R5+R6)/(R5−R6)≤−0.17. It specifies the shape of the third lens L3. When within this range, it helps correct axial chromatic aberration and other issues, which is beneficial for the development of ultra-thin and wide-angle lenses.

An on-axis thickness of the third lens L3 is d5, and a total optical length of the imaging optical lens 10, 20, 30, 40, 50, 60, and 70 is TTL. The following relationship formula should be satisfied: 0.06≤d5/TTL≤0.13. Within this range, it is beneficial for achieving ultra-thinness.

In an embodiment, an object-side surface of the fourth lens L4 is concave in a paraxial region, and the image-side surface of the fourth lens L4 is convex in a paraxial region. The object-side surface and the image-side surface of the fourth lens L4 may also be configured with other concave and convex distributions.

A focal length of the imaging optical lens 10, 20, 30, 40, 50, 60, and 70 is defined as f, and a focal length of the fourth lens L4 is defined as f4. The following relationship formula should be satisfied: 1.70≤f4/f≤1.96. By controlling the positive optical power of the fourth lens L4 within a reasonable range, it is beneficial to correct aberrations of the optical system.

A central curvature radius of the object-side surface of the fourth lens L4 is R7, and a central curvature radius of the image-side surface of the fourth lens L4 is R8. The following relationship formula should be satisfied: −0.85≤(R7+R8)/(R7−R8)≤−0.50. It specifies the shape of the fourth lens L4. When within this range, it helps correct axial chromatic aberration and other issues, which is beneficial for the development of ultra-thin and wide-angle lenses.

An on-axis thickness of the fourth lens L4 is d7, and a total optical length of the imaging optical lens 10, 20, 30, 40, 50, 60, and 70 is TTL. The following relationship formula should be satisfied: 0.04≤d7/TTL≤0.06. Within this range, it is beneficial to realize ultra-thinness.

In an embodiment, an object-side surface of the fifth lens L5 is concave in a paraxial region, and an image-side surface of the fifth lens L5 is convex in a paraxial region. The object-side surface and the image-side surface of the fifth lens L5 may also be configured with other concave and convex distributions.

A focal length of the fifth lens L5 is defined as f5. The following relationship formula should be satisfied: −1.60≤f5/f≤−1.40. Limiting the fifth lens L5 within this range can effectively moderate the light ray angle of the imaging optical lens 10, thereby reducing tolerance sensitivity.

A central curvature radius of the object-side surface of the fifth lens L5 is R9, and a central curvature radius of the image-side surface of the fifth lens L5 is R10. The following relationship formula should be satisfied: 0.20≤(R9+R10)/(R9−R10)≤0.42. It specifies the shape of the fifth lens L5 and is beneficial for its molding. When within this range, it helps correct aberrations of off-axis angles and other issues, which is beneficial for developing ultra-thin and wide-angle designs.

An on-axis thickness of the fifth lens L5 is d9. The following relationship formula should be satisfied: 0.02≤d9/TTL≤0.04. Within the range, it is beneficial for achieving ultra-thinness.

In an embodiment, an object-side surface of the sixth lens L6 is concave in a paraxial region, and an image-side surface of the sixth lens L6 is convex in a paraxial region. The object-side surface and the image-side surface of the sixth lens L6 may also be configured with other concave and convex distributions.

A focal length of the imaging optical lens is defined as f, and a focal length of the sixth lens L6 is defined as f6. The following relationship formula should be satisfied: −13.50≤f6/f≤72.00. Through the reasonable distribution of the optical power of the sixth lens L3, the system has better imaging quality and lower sensitivity.

An on-axis thickness of the sixth lens L6 is d11. The following relationship formula should be satisfied: 0.02≤d11/TTL≤0.05. Within the range, it is beneficial for achieving ultra-thinness.

In an embodiment, an object-side surface of the seventh lens L7 is concave in a paraxial region, and an image-side surface of the seventh lens L7 is convex in a paraxial region. The object-side surface and the image-side surface of the seventh lens L7 may also be configured with other concave and convex distributions.

A central curvature radius of the object-side surface of the seventh lens L7 is R13, and a central curvature radius of the image-side surface of the seventh lens L7 is R14. The following relationship formula should be satisfied: −3.80≤(R13+R14)/(R13−R14)≤−2.20. It specifies the shape of the seventh lens L7. When within this range, it helps correct axial chromatic aberration and other issues, which is beneficial for the development of ultra-thin and wide-angle lenses.

An on-axis thickness of the seventh lens L7 is d13. The following relationship formula should be satisfied: 0.02≤d13/TTL≤0.09. Within the range, it is beneficial for achieving ultra-thinness.

In an embodiment, the f-number (FNO) of the imaging optical lens is less than or equal to 2.30, and the Field of view angle (FOV) of the 1.0 field of view of the imaging optical lens is greater than or equal to 154.67°, thus achieving a wide-angle design.

In an embodiment, a total optical length TTL of the imaging optical lens 10, 20, 30, 40, 50, 60, and 70 is less than or equal to 11.25 mm, it is beneficial for achieving ultra-thinness.

The design minimizes the total optical length TTL of the entire imaging optical lens 10, 20, 30, 40, 50, 60, and 70, while maintaining miniaturization.

FNO refers to the f-number of the imaging optical lens 10, 20, 30, 40, 50, 60, and 70, i.e., FNO defines the ratio of the effective focal length of the imaging optical lens to the pupil entering diameter, satisfying the following relationship formula: FNO≤2.37, it is beneficial for achieving a large aperture and ensuring good image performance. The field of view angle is FOV, satisfying the following relationship formula: FOV≥154°, it is beneficial for achieving a wide-angle design. That is, when the above relationships are satisfied, the imaging optical lenses 10, 20, 30, 40, 50, 60, and 70 achieve good optical imaging performance while meeting the design requirements of a large aperture and an ultra-thinness. According to the characteristics of the imaging optical lenses 10, 20, 30, 40, 50, 60, and 70, the imaging optical lenses 10, 20, 30, 40, 50, 60, and 70 are particularly suitable for action cameras, mobile phone camera lens modules, and WEB camera lenses equipped with high-pixel CCD, CMOS, and other imaging elements.

The first lens L1, the third lens L3, and the seventh lens L7 are made of glass, and the second lens L2, the fourth lens L4, the fifth lens L5, and the sixth lens L6 are made of plastic. Each lens may also be made of other materials.

The imaging optical lens of the present disclosure will be described below with embodiments. The symbols used in each embodiment are defined as follows: the units of focal length, on-axis distance, central curvature radius, on-axis thickness, inflection point position, and stagnation point position are millimeters (mm).

TTL: a total optical length (the on-axis distance from the object-side surface of the first lens L1 to the image surface Si), in millimeters (mm).

F-number (FNO): the ratio of the effective focal length of the imaging optical lens to the pupil entering diameter.

Image height (IH) of 1.0 field of view: the field height corresponding to the effective pixel of the sensor (i.e., half of the diagonal length of the effective pixel area of the sensor);

Field of view angle (FOV) of 1.0 field of view: the field angle corresponding to the effective pixel of the sensor;

Preferably, the object-side surface and/or image-side surface of the lens may also be provided with inflection points and/or stagnation points to meet high-quality imaging requirements.

Next, the technical solution of the present disclosure will be specifically described with seven embodiments, and a comparative embodiment will be provided as a reference to illustrate that the technical effects of the present disclosure cannot be achieved when exceeding the range of the above relationships.

### First Embodiment

FIG. 1 shows the imaging optical lens 20 according to the first embodiment of the present disclosure. The sixth lens L6 has negative refractive power.

Tables 1 and 2 show the design data of the imaging optical lens 10 according to the first embodiment of the present disclosure.

TABLE 1

| | R | d | | nd | | vd | |
|---|---|---|---|---|---|---|---|
| S1 | ∞ | d0= | −4.947 | | | | |
| R1 | 18.794 | d1= | 0.400 | nd1 | 1.8348 | v1 | 42.73 |
| R2 | 1.844 | d2= | 1.393 | | | | |
| R3 | −71.455 | d3= | 1.643 | nd2 | 1.6607 | v2 | 20.53 |
| R4 | −7.263 | d4= | 0.100 | | | | |
| R5 | 3.224 | d5= | 1.008 | nd3 | 1.6169 | v3 | 63.79 |
| R6 | −4.697 | d6= | 0.379 | | | | |
| R7 | 2.461 | d7= | 0.480 | nd4 | 1.5367 | v4 | 55.99 |
| R8 | −8.711 | d8= | 0.061 | | | | |
| R9 | −6.189 | d9= | 0.300 | nd5 | 1.6607 | v5 | 20.53 |
| R10 | 3.003 | d10= | 0.326 | | | | |
| R11 | 2.943 | d11= | 0.400 | nd6 | 1.5367 | v6 | 55.99 |
| R12 | 2.328 | d12= | 0.452 | | | | |
| R13 | 3.520 | d13= | 0.704 | nd7 | 1.6169 | v7 | 63.79 |
| R14 | 6.481 | d14= | 0.424 | | | | |
| R15 | ∞ | d15= | 0.300 | ndg | 1.5233 | vg | 54.52 |
| R16 | ∞ | d16= | 0.630 | | | | |

The meanings of the symbols are as follows:
S1: aperture;
R: the curvature radius at the center of the optical surface;
R1: the central curvature radius of the object-side surface of the first lens L1;
R2: the central curvature radius of the image-side surface of the first lens L1;
R3: the central curvature radius of the object-side surface of the second lens L2;
R4: the central curvature radius of the image-side surface of the second lens L2;
R5: the central curvature radius of the object-side surface of the third lens L3;
R6: the central curvature radius of the image-side surface of the third lens L3;
R7: the central curvature radius of the object-side surface of the fourth lens L4;
R8: the central curvature radius of the image-side surface of the fourth lens L4;
R9: the central curvature radius of the object-side surface of the fifth lens L5;
R10: the central curvature radius of the image-side surface of the fifth lens L5;
R11: the central curvature radius of the object-side surface of the sixth lens L6;
R12: the central curvature radius of the image-side surface of the sixth lens L6;
R13: the central curvature radius of the object-side surface of the seventh lens L7;
R14: the central curvature radius of the image-side surface of the seventh lens L7;
R15: the central curvature radius of the object-side surface of the optical filter GF;
R16: the central curvature radius of the image-side surface of the optical filter GF;
d: the on-axis thickness of the lens, or the on-axis distance between lenses;
d0: the on-axis distance from the aperture S1 to the object-side surface of the first lens L1;
d1: the on-axis thickness of the first lens L1;
d2: the on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: the on-axis thickness of the third lens L3;
d6: the on-axis distance from the image-side surface of the third lens L3 to the object-side surface of the fourth lens L4;
d7: the on-axis thickness of the fourth lens L4;
d8: the on-axis distance from the image-side surface of the fourth lens L4 to the object-side surface of the fifth lens L5;
d9: the on-axis thickness of the fifth lens L5;
d10: the on-axis distance from the image-side surface of the fifth lens L5 to the object-side surface of the sixth lens L6;
d11: the on-axis thickness of the sixth lens L6;
d12: the on-axis distance from the image-side surface of the sixth lens L6 to the object-side surface of the seventh lens L7;
d13: the on-axis thickness of the seventh lens L7;
d14: the on-axis distance from the image-side surface of the seventh lens L7 to the object-side surface of the optical filter GF;
d15: the on-axis thickness of the optical filter GF;
d16: the on-axis distance from the image-side surface of the optical filter GF to the image surface Si;
nd: the refractive index of the d-line (the d-line refers to green light with a wavelength of 550 nm);
nd1: the refractive index of the d-line of the first lens L1;
nd2: the refractive index of the d-line of the second lens L2;
nd3: the refractive index of the d-line of the third lens L3;
nd4: the refractive index of the d-line of the fourth lens L4;
nd5: the refractive index of the d-line of the fifth lens L5;
nd6: the refractive index of the d-line of the sixth lens L6;
nd7: the refractive index of the d-line of the seventh lens L7;
ndg: the refractive index of the d-line of the optical filter GF;
vd: the Abbe number;
v1: the Abbe number of the first lens L1;
v2: the Abbe number of the second lens L2;
v3: the Abbe number of the third lens L3;
v4: the Abbe number of the fourth lens L4;
v5: the Abbe number of the fifth lens L5;
v6: the Abbe number of the sixth lens L6;
v7: the Abbe number of the seventh lens L7;
vg: the Abbe number of the optical filter GF.

Table 2 shows the aspherical data of each lens in the imaging optical lens 10 according to the first embodiment of the present disclosure.

TABLE 2

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | −9.9500E+01 | −1.4528E−02 | 6.1016E−04 | 4.4373E−04 | −1.0831E−03 | 6.3055E−04 |
| R4 | −6.9184E+01 | −5.0600E−03 | −8.4412E−03 | 8.8234E−03 | −5.9044E−03 | 2.5812E−03 |
| R5 | −2.2662E+01 | 1.0605E−01 | −1.0122E−01 | 8.8596E−02 | −6.1216E−02 | 2.7760E−02 |
| R6 | 5.4822E+00 | 5.2541E−03 | 7.6120E−03 | −8.1714E−03 | 4.1349E−03 | 6.4224E−04 |
| R7 | −6.6561E+00 | 4.2629E−02 | −1.6893E−02 | 1.3233E−01 | −6.3043E−01 | 1.4396E+00 |
| R8 | −6.4925E+01 | −1.4543E−01 | 4.8169E−01 | −1.3775E+00 | 2.6946E+00 | −3.3388E+00 |
| R9 | −6.9363E+00 | −5.5886E−02 | 5.6667E−01 | −2.0479E+00 | 4.4246E+00 | −5.8727E+00 |
| R10 | 4.8854E+00 | 1.4560E−02 | 2.6317E−01 | −9.0725E−01 | 1.6800E+00 | −1.8242E+00 |
| R11 | −3.3750E+01 | −6.1643E−02 | 8.3039E−02 | −2.5800E−01 | 4.2048E−01 | −4.1709E−01 |
| R12 | −1.7833E+01 | −4.5459E−02 | 5.3383E−02 | −6.7186E−02 | 4.9795E−02 | −2.2568E−02 |
| R13 | −8.1481E+00 | −6.1680E−02 | 3.7041E−02 | −1.1833E−02 | 1.7151E−03 | 3.7497E−04 |
| R14 | 3.2219E+00 | −3.7922E−02 | −9.0854E−04 | 1.0117E−02 | −7.0725E−03 | 2.8605E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | −9.9500E+01 | −1.6775E−04 | 1.9163E−05 | / | / |
| R4 | −6.9184E+01 | −5.7616E−04 | 5.0035E−05 | / | / |
| R5 | −2.2662E+01 | −6.9154E−03 | 7.1966E−04 | / | / |
| R6 | 5.4822E+00 | −9.9647E−04 | 2.2452E−04 | / | / |
| R7 | −6.6561E+00 | −1.5798E+00 | 6.6745E−01 | / | / |
| R8 | −6.4925E+01 | 2.3516E+00 | −7.7909E−01 | / | / |
| R9 | −6.9363E+00 | 4.3625E+00 | −1.4495E+00 | / | / |
| R10 | 4.8854E+00 | 1.0878E+00 | −2.8401E−01 | / | / |
| R11 | −3.3750E+01 | 2.3200E−01 | −5.1772E−02 | / | / |
| R12 | −1.7833E+01 | 5.9233E−03 | −6.6785E−04 | / | / |
| R13 | −8.1481E+00 | −2.7002E−04 | 6.6083E−05 | −7.9877E−06 | 3.9196E−07 |
| R14 | 3.2219E+00 | −7.3603E−04 | 1.1784E−04 | −1.0658E−05 | 4.1276E−07 |

Both R1 and R2 are spherical surfaces.

For convenience, the aspherical surfaces of each lens adopt the aspherical surface shown in the following formula (1). However, the present disclosure is not limited to the aspherical polynomial form represented by the relationship formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 1 )$$

In an embodiment, k is the conic coefficient, A4, A6, A8, A10, A12, A14, A16, A18, and A20 are aspherical coefficients, c is the curvature at the center of the optical surface, r is the vertical distance from a point on the aspherical curve to the optical axis, z is the aspherical depth (the vertical distance between a point on the aspherical surface at a distance r from the optical axis and the tangent plane at the vertex of the aspherical surface on the optical axis).

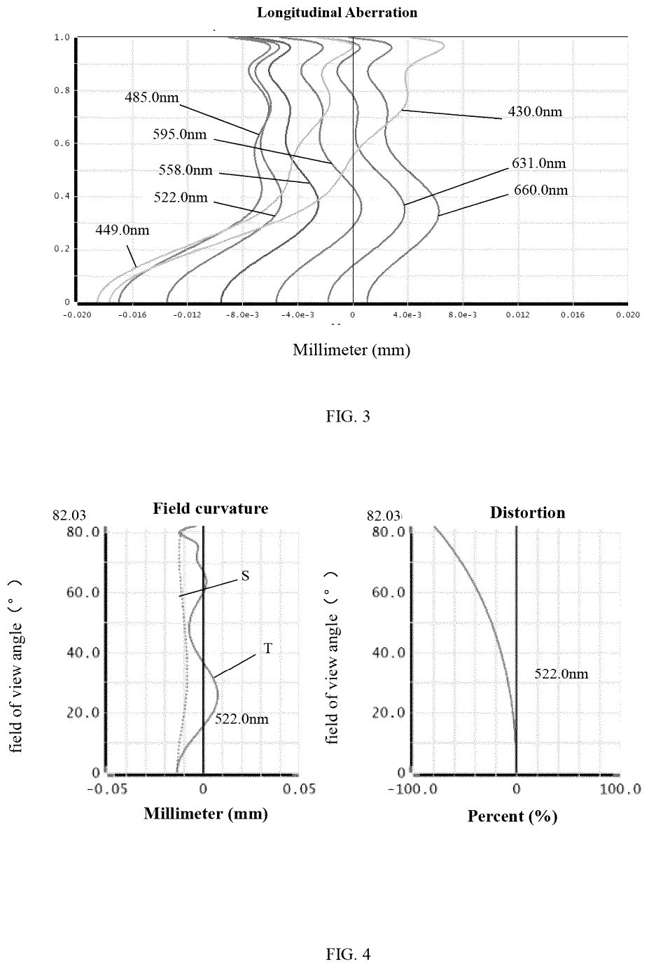

FIG. 2 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 10 of the first embodiment. FIG. 3 shows a schematic diagram of longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 10 of the first embodiment. FIG. 4 shows a schematic diagram of field curvature and distortion of light with a wavelength of 522.0 nm after passing through the imaging optical lens 10 of the first embodiment, where the field curvature S in FIG. 4 is the field curvature in the sagittal direction, and T is the field curvature in the meridional direction.

In an embodiment, the pupil entering diameter (ENPD) of the imaging optical lens 10 is 2.299 mm, the Image Height (IH) of the 1.0 field of view is 3.000 mm, and the field of view angle (FOV) of the 1.0 field of view is 164.05°. The imaging optical lens 10 meets the design requirements of a large aperture, ultra-wide angle, and ultra-thinness, and its on-axis and off-axis chromatic aberrations are fully corrected, with excellent optical characteristics.

### Second Embodiment

The symbols in the second embodiment have the same meanings as those in the first embodiment.

FIG. 5 shows the imaging optical lens 20 according to the second embodiment of the present disclosure.

Tables 3 and 4 show the design data of the imaging optical lens 20 according to the second embodiment of the present disclosure.

TABLE 3

| | R | d | | nd | | vd | |
|---|---|---|---|---|---|---|---|
| S1 | ∞ | d0= | −5.248 | | | | |
| R1 | 19.868 | d1= | 0.534 | nd1 | 1.8348 | v1 | 42.73 |
| R2 | 1.850 | d2= | 1.362 | | | | |
| R3 | −70.268 | d3= | 1.617 | nd2 | 1.6607 | v2 | 20.53 |
| R4 | −7.292 | d4= | 0.117 | | | | |
| R5 | 3.216 | d5= | 1.090 | nd3 | 1.6169 | v3 | 63.79 |
| R6 | −4.682 | d6= | 0.302 | | | | |
| R7 | 2.425 | d7= | 0.501 | nd4 | 1.5367 | v4 | 55.99 |
| R8 | −9.355 | d8= | 0.072 | | | | |
| R9 | −6.949 | d9= | 0.314 | nd5 | 1.6607 | v5 | 20.53 |
| R10 | 2.939 | d10= | 0.339 | | | | |
| R11 | 3.030 | d11= | 0.379 | nd6 | 1.5367 | v6 | 55.99 |
| R12 | 2.060 | d12= | 0.472 | | | | |
| R13 | 3.219 | d13= | 0.677 | nd7 | 1.6169 | v7 | 63.79 |
| R14 | 8.103 | d14= | 0.430 | | | | |
| R15 | ∞ | d15= | 0.300 | ndg | 1.5233 | vg | 54.52 |
| R16 | ∞ | d16= | 0.637 | | | | |

Table 4 shows the aspherical data of each lens in the imaging optical lens 20 according to the second embodiment of the present disclosure.

TABLE 4

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | 3.8417E+02 | −1.4438E−02 | 5.3216E−04 | 4.0297E−04 | −1.0799E−03 | 6.3603E−04 |
| R4 | −6.2874E+01 | −4.9438E−03 | −8.2359E−03 | 8.8954E−03 | −5.8469E−03 | 2.5957E−03 |
| R5 | −2.2241E+01 | 1.0619E−01 | −1.0067E−01 | 8.8747E−02 | −6.1186E−02 | 2.7760E−02 |
| R6 | 5.6954E+00 | 4.8829E−03 | 7.2275E−03 | −8.2590E−03 | 4.1461E−03 | 6.6033E−04 |
| R7 | −6.3553E+00 | 4.1915E−02 | −2.2835E−02 | 1.2718E−01 | −6.3083E−01 | 1.4452E+00 |
| R8 | −1.2351E+02 | −1.4295E−01 | 4.7643E−01 | −1.3800E+00 | 2.6967E+00 | −3.3312E+00 |
| R9 | −7.4843E+00 | −5.5019E−02 | 5.7266E−01 | −2.0535E+00 | 4.4219E+00 | −5.8576E+00 |
| R10 | 4.9575E+00 | 1.6484E−02 | 2.5892E−01 | −9.0749E−01 | 1.6793E+00 | −1.8226E+00 |
| R11 | −5.7138E+01 | −6.8003E−02 | 8.3409E−02 | −2.5757E−01 | 4.1885E−01 | −4.1865E−01 |
| R12 | −2.0280E+01 | −4.7081E−02 | 5.4182E−02 | −6.7315E−02 | 4.9769E−02 | −2.2541E−02 |
| R13 | −9.4343E+00 | −6.1520E−02 | 3.6862E−02 | −1.1848E−02 | 1.7143E−03 | 3.7493E−04 |
| R14 | 1.0644E+00 | −3.9377E−02 | −5.8080E−04 | 1.0089E−02 | −7.0699E−03 | 2.8602E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | 3.8417E+02 | −1.6671E−04 | 2.0028E−05 | 0.0000E+00 | 0.0000E+00 |
| R4 | −6.2874E+01 | −5.6954E−04 | 5.1548E−05 | 0.0000E+00 | 0.0000E+00 |
| R5 | −2.2241E+01 | −6.9160E−03 | 7.1678E−04 | 0.0000E+00 | 0.0000E+00 |
| R6 | 5.6954E+00 | −9.9739E−04 | 2.2071E−04 | 0.0000E+00 | 0.0000E+00 |
| R7 | −6.3553E+00 | −1.5747E+00 | 6.4875E−01 | 0.0000E+00 | 0.0000E+00 |
| R8 | −1.2351E+02 | 2.3560E+00 | −8.0025E−01 | 0.0000E+00 | 0.0000E+00 |
| R9 | −7.4843E+00 | 4.3866E+00 | −1.4859E+00 | 0.0000E+00 | 0.0000E+00 |
| R10 | 4.9575E+00 | 1.0900E+00 | −2.8771E−01 | 0.0000E+00 | 0.0000E+00 |
| R11 | −5.7138E+01 | 2.3213E−01 | −4.9830E−02 | 0.0000E+00 | 0.0000E+00 |
| R12 | −2.0280E+01 | 5.9330E−03 | −6.7173E−04 | 0.0000E+00 | 0.0000E+00 |
| R13 | −9.4343E+00 | −2.7002E−04 | 6.6084E−05 | −7.9879E−06 | 3.9178E−07 |
| R14 | 1.0644E+00 | −7.3613E−04 | 1.1783E−04 | −1.0660E−05 | 4.1260E−07 |

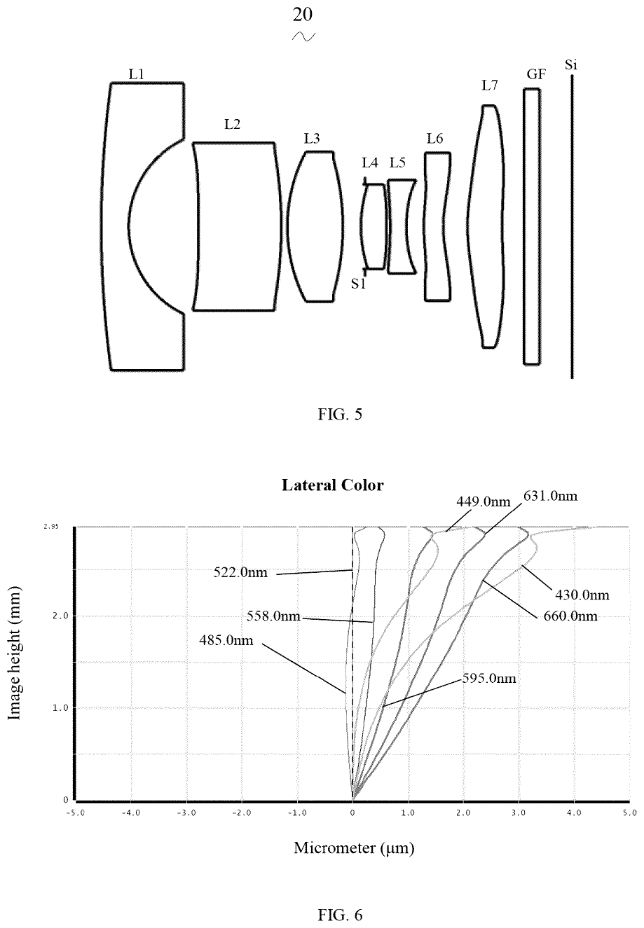

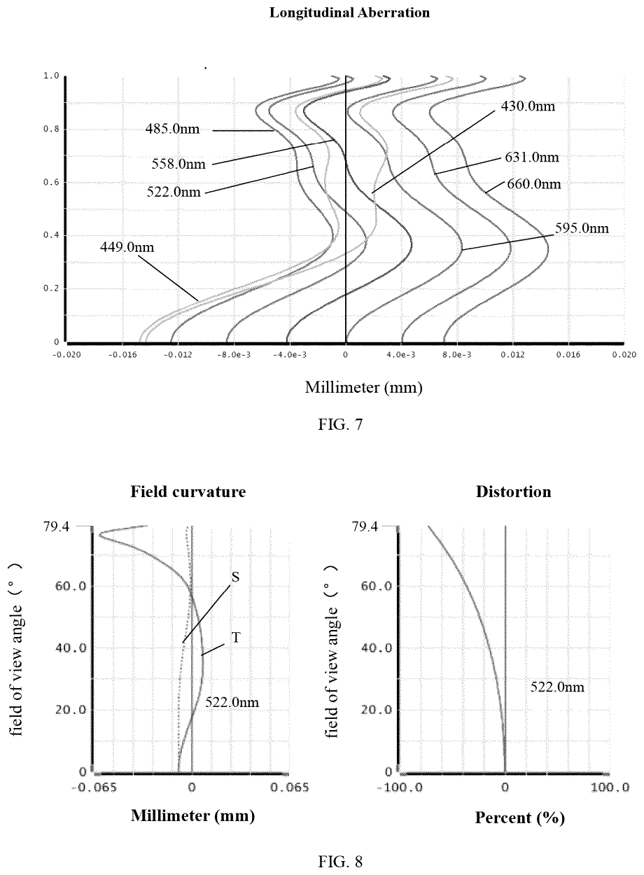

FIG. 6 shows a schematic diagram of the lateral color of light with wavelengths of 430.0 nm, 449.0 nm, 485.0 nm, 522.0 nm, 558.0 nm, 595.0 nm, 631.0 nm and 660.0 nm after passing through the imaging optical lens 20 of the second embodiment. FIG. 7 shows a schematic diagram of axial aberration of light with wavelengths of 430.0 nm, 449.0 nm, 485.0 nm, 522.0 nm, 558.0 nm, 595.0 nm, 631.0 nm, and 660.0 nm after passing through the imaging optical lens 20 of the second embodiment. FIG. 8 shows a schematic diagram of field curvature and distortion of light with a wavelength of 522.0 nm after passing through the imaging optical lens 20 of the second embodiment, where the field curvature S in FIG. 8 is the field curvature in the sagittal direction, and T is the field curvature in the meridional direction.

In an embodiment, the pupil entering diameter (ENPD) of the imaging optical lens 20 is 2.300 mm, the image height (IH) of the 1.0 field of view is 2.950 mm, and the Field of view angle (FOV) of the 1.0 field of view is 158.84°. The imaging optical lens 20 meets the design requirements of a large aperture, an ultra-wide angle, and ultra-thinness, and its on-axis and off-axis chromatic aberrations are fully corrected, with excellent optical characteristics.

### Third Embodiment

The symbols in the third embodiment have the same meanings as those in the first embodiment.

FIG. 9 shows the imaging optical lens 30 according to the third embodiment of the present disclosure.

Tables 5 and 6 show the design data of the imaging optical lens 30 according to the third embodiment of the present disclosure.

TABLE 5

| | R | d | | nd | | vd | |
|---|---|---|---|---|---|---|---|
| S1 | ∞ | d0= | −6.455 | | | | |
| R1 | 22.476 | d1= | 1.621 | nd1 | 1.8348 | v1 | 42.73 |
| R2 | 1.868 | d2= | 1.408 | | | | |
| R3 | −55.559 | d3= | 1.718 | nd2 | 1.6607 | v2 | 20.53 |
| R4 | −7.464 | d4= | 0.158 | | | | |
| R5 | 3.195 | d5= | 1.064 | nd3 | 1.6169 | v3 | 63.79 |
| R6 | −4.634 | d6= | 0.305 | | | | |
| R7 | 2.273 | d7= | 0.504 | nd4 | 1.5367 | v4 | 55.99 |
| R8 | −10.785 | d8= | 0.069 | | | | |
| R9 | −6.600 | d9= | 0.327 | nd5 | 1.6607 | v5 | 20.53 |
| R10 | 2.963 | d10= | 0.337 | | | | |
| R11 | 2.831 | d11= | 0.415 | nd6 | 1.5367 | v6 | 55.99 |
| R12 | 2.187 | d12= | 0.467 | | | | |
| R13 | 3.703 | d13= | 0.803 | nd7 | 1.6169 | v7 | 63.79 |
| R14 | 7.069 | d14= | 0.261 | | | | |
| R15 | ∞ | d15= | 0.300 | ndg | 1.5233 | vg | 54.52 |
| R16 | ∞ | d16= | 0.466 | | | | |

Table 6 shows the aspherical data of each lens in the imaging optical lens 30 according to the third embodiment of the present disclosure.

TABLE 6

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | −9.3094E+02 | −1.4338E−02 | 2.4528E−04 | 4.1115E−04 | −1.0633E−03 | 6.3997E−04 |
| R4 | −6.9766E+01 | −4.4264E−03 | −8.1082E−03 | 8.9291E−03 | −5.8651E−03 | 2.5932E−03 |
| R5 | −2.1522E+01 | 1.0589E−01 | −1.0089E−01 | 8.8762E−02 | −6.1198E−02 | 2.7744E−02 |
| R6 | 5.6150E+00 | 4.8527E−03 | 7.2757E−03 | −8.2183E−03 | 4.1625E−03 | 6.5746E−04 |
| R7 | −5.7834E+00 | 4.4641E−02 | −2.2957E−02 | 1.2463E−01 | −6.3363E−01 | 1.4442E+00 |
| R8 | −8.5773E+01 | −1.4495E−01 | 4.6753E−01 | −1.3780E+00 | 2.7090E+00 | −3.3257E+00 |
| R9 | −1.1017E+00 | −5.8818E−02 | 5.7999E−01 | −2.0490E+00 | 4.4126E+00 | −5.8789E+00 |
| R10 | 5.2149E+00 | 2.0219E−02 | 2.6154E−01 | −9.0664E−01 | 1.6779E+00 | −1.8269E+00 |
| R11 | −4.1378E+01 | −6.0947E−02 | 8.1406E−02 | −2.5934E−01 | 4.1956E−01 | −4.1776E−01 |
| R12 | −1.9724E+01 | −4.8007E−02 | 5.3414E−02 | −6.7376E−02 | 4.9693E−02 | −2.2602E−02 |
| R13 | −1.2125E+01 | −6.2821E−02 | 3.7013E−02 | −1.1836E−02 | 1.7147E−03 | 3.7495E−04 |
| R14 | −1.9331E−01 | −4.1442E−02 | −5.7398E−04 | 1.0070E−02 | −7.0733E−03 | 2.8609E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | −9.3094E+02 | −1.6548E−04 | 1.8632E−05 | 0.0000E+00 | 0.0000E+00 |
| R4 | −6.9766E+01 | −5.7324E−04 | 4.9296E−05 | 0.0000E+00 | 0.0000E+00 |
| R5 | −2.1522E+01 | −6.9299E−03 | 7.1736E−04 | 0.0000E+00 | 0.0000E+00 |
| R6 | 5.6150E+00 | −9.9829E−04 | 2.1545E−04 | 0.0000E+00 | 0.0000E+00 |
| R7 | −5.7834E+00 | −1.5724E+00 | 6.5400E−01 | 0.0000E+00 | 0.0000E+00 |
| R8 | −8.5773E+01 | 2.3386E+00 | −8.4929E−01 | 0.0000E+00 | 0.0000E+00 |
| R9 | −1.1017E+00 | 4.3694E+00 | −1.4565E+00 | 0.0000E+00 | 0.0000E+00 |
| R10 | 5.2149E+00 | 1.0846E+00 | −2.8774E−01 | 0.0000E+00 | 0.0000E+00 |
| R11 | −4.1378E+01 | 2.3162E−01 | −5.1833E−02 | 0.0000E+00 | 0.0000E+00 |
| R12 | −1.9724E+01 | 5.9120E−03 | −6.7709E−04 | 0.0000E+00 | 0.0000E+00 |
| R13 | −1.2125E+01 | −2.7001E−04 | 6.6092E−05 | −7.9850E−06 | 3.9254E−07 |
| R14 | −1.9331E−01 | −7.3595E−04 | 1.1785E−04 | −1.0656E−05 | 4.1293E−07 |

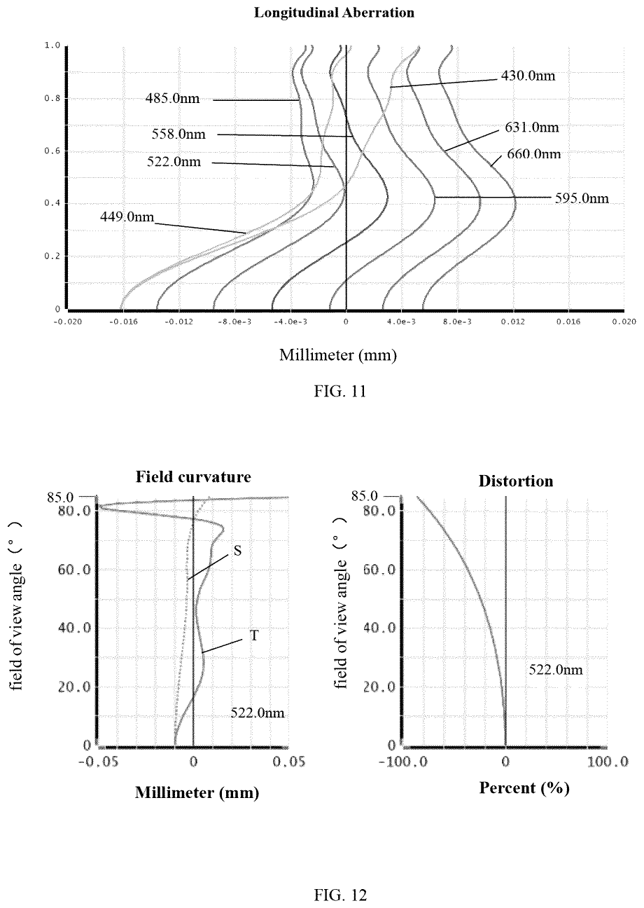

FIG. 10 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 30 of the third embodiment. FIG. 11 shows a schematic diagram of axial aberration of light with wavelengths of 430.0 nm, 449.0 nm, 485.0 nm, 522.0 nm, 558.0 nm, 595.0 nm, 631.0 nm, and 660.0 nm after passing through the imaging optical lens 30 of the third embodiment. FIG. 12 shows a schematic diagram of field curvature and distortion of light with a wavelength of 522.0 nm after passing through the imaging optical lens 30 of the third embodiment, where the field curvature S in FIG. 12 is the field curvature in the sagittal direction, and T is the field curvature in the meridional direction.

In an embodiment, the pupil entering diameter (ENPD) of the imaging optical lens 30 is 2.300 mm, the Image Height (IH) of the 1.0 field of view is 2.950 mm, and the Field of view angle (FOV) of the 1.0 field of view is 170.04°. The imaging optical lens 30 meets the design requirements of a large aperture, ultra-wide angle and ultra-thinness, and its on-axis and off-axis chromatic aberrations are fully corrected, with excellent optical characteristics.

### Fourth Embodiment

The symbols in the fourth embodiment have the same meanings as those in the first embodiment.

FIG. 13 shows the imaging optical lens 40 according to the fourth embodiment of the present disclosure.

Tables 7 and 8 show the design data of the imaging optical lens 40 according to the fourth embodiment of the present disclosure.

TABLE 7

| | R | d | | nd | | vd | |
|---|---|---|---|---|---|---|---|
| S1 | ∞ | d0= | −4.890 | | | | |
| R1 | 19.537 | d1= | 0.300 | nd1 | 1.8348 | v1 | 42.73 |
| R2 | 1.782 | d2= | 1.457 | | | | |
| R3 | −75.888 | d3= | 1.528 | nd2 | 1.6607 | v2 | 20.53 |
| R4 | −7.385 | d4= | 0.129 | | | | |
| R5 | 3.210 | d5= | 0.989 | nd3 | 1.6169 | v3 | 63.79 |
| R6 | −4.702 | d6= | 0.341 | | | | |
| R7 | 2.534 | d7= | 0.459 | nd4 | 1.5367 | v4 | 55.99 |
| R8 | −8.377 | d8= | 0.068 | | | | |
| R9 | −6.313 | d9= | 0.283 | nd5 | 1.6607 | v5 | 20.53 |
| R10 | 3.078 | d10= | 0.251 | | | | |
| R11 | 2.389 | d11= | 0.250 | nd6 | 1.5367 | v6 | 55.99 |
| R12 | 1.839 | d12= | 0.293 | | | | |
| R13 | 3.143 | d13= | 0.254 | nd7 | 1.6169 | v7 | 63.79 |
| R14 | 6.060 | d14= | 0.841 | | | | |
| R15 | ∞ | d15= | 0.300 | ndg | 1.5233 | vg | 54.52 |
| R16 | ∞ | d16= | 1.049 | | | | |

Table 8 shows the aspherical data of each lens in the imaging optical lens 40 according to the fourth embodiment of the present disclosure.

TABLE 8

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | 2.1744E+03 | −1.6281E−02 | 2.4731E−04 | 4.8265E−04 | −1.0407E−03 | 6.5119E−04 |
| R4 | −5.8438E+01 | −5.5729E−03 | −8.4419E−03 | 8.8615E−03 | −5.8828E−03 | 2.5856E−03 |
| R5 | −2.1940E+01 | 1.0559E−01 | −1.0115E−01 | 8.8632E−02 | −6.1220E−02 | 2.7763E−02 |
| R6 | 5.4528E+00 | 5.3408E−03 | 7.5257E−03 | −8.1942E−03 | 4.1656E−03 | 6.5473E−04 |
| R7 | −6.3643E+00 | 4.2357E−02 | −1.8508E−02 | 1.3779E−01 | −6.1802E−01 | 1.4532E+00 |
| R8 | −1.0229E+02 | −1.4114E−01 | 4.8623E−01 | −1.3696E+00 | 2.7046E+00 | −3.3303E+00 |
| R9 | −1.7501E+01 | −5.1950E−02 | 5.6810E−01 | −2.0501E+00 | 4.4249E+00 | −5.8668E+00 |
| R10 | 4.7383E+00 | 1.0957E−02 | 2.6570E−01 | −9.0208E−01 | 1.6831E+00 | −1.8232E+00 |
| R11 | −4.2927E+01 | −7.0008E−02 | 7.8748E−02 | −2.5868E−01 | 4.2192E−01 | −4.1479E−01 |
| R12 | −1.9386E+01 | −4.1339E−02 | 5.5121E−02 | −6.6972E−02 | 4.9732E−02 | −2.2582E−02 |
| R13 | −1.3643E+01 | −5.8825E−02 | 3.7238E−02 | −1.1908E−02 | 1.6983E−03 | 3.7170E−04 |
| R14 | −2.6431E+00 | −4.2733E−02 | −8.9069E−04 | 1.0335E−02 | −7.0238E−03 | 2.8644E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | 2.1744E+03 | −1.6377E−04 | 1.6478E−05 | 0.0000E+00 | 0.0000E+00 |
| R4 | −5.8438E+01 | −5.7594E−04 | 5.1100E−05 | 0.0000E+00 | 0.0000E+00 |
| R5 | −2.1940E+01 | −6.9099E−03 | 7.2416E−04 | 0.0000E+00 | 0.0000E+00 |
| R6 | 5.4528E+00 | −9.9344E−04 | 2.2458E−04 | 0.0000E+00 | 0.0000E+00 |
| R7 | −6.3643E+00 | −1.5769E+00 | 6.3935E−01 | 0.0000E+00 | 0.0000E+00 |
| R8 | −1.0229E+02 | 2.3543E+00 | −7.8571E−01 | 0.0000E+00 | 0.0000E+00 |
| R9 | −1.7501E+01 | 4.3710E+00 | −1.4498E+00 | 0.0000E+00 | 0.0000E+00 |
| R10 | 4.7383E+00 | 1.0889E+00 | −2.8052E−01 | 0.0000E+00 | 0.0000E+00 |
| R11 | −4.2927E+01 | 2.3523E−01 | −4.7942E−02 | 0.0000E+00 | 0.0000E+00 |
| R12 | −1.9386E+01 | 5.9472E−03 | −6.4973E−04 | 0.0000E+00 | 0.0000E+00 |
| R13 | −1.3643E+01 | −2.7170E−04 | 6.5225E−05 | −8.2236E−06 | 4.7290E−07 |
| R14 | −2.6431E+00 | −7.3707E−04 | 1.1721E−04 | −1.0931E−05 | 2.6080E−07 |

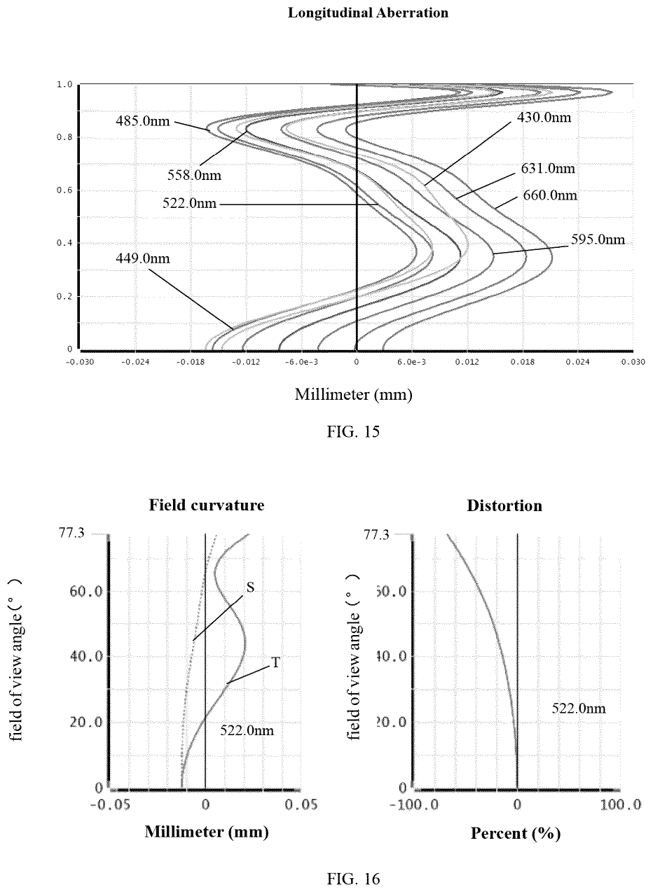

FIG. 14 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 40 of the fourth embodiment. FIG. 15 shows a schematic diagram of the longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 10 of the fourth embodiment. FIG. 16 shows a schematic diagram of the field curvature and distortion of light with a wavelength of 522.0 nm after passing through the imaging optical lens 40 of the first embodiment. In FIG. 16, the field curvature S is the field curvature in the sagittal direction, and T is the field curvature in the meridional direction.

In this embodiment, the pupil entering diameter (ENPD) of the imaging optical lens is 2.301 mm, the image height IH of the 1.0 field of view is 2.960 mm, and the field of view angle FOV of the 1.0 field of view is 154.67°, so that the imaging optical lens 40 meets the design requirements of a large aperture, ultra-wide angle, and ultra-thinness. Its on-axis and off-axis chromatic aberrations are fully corrected, and it has excellent optical characteristics.

### Fifth Embodiment

The symbol meanings of the fifth embodiment are the same as those of the first embodiment.

TABLE 9

| | R | d | | nd | | vd | |
|---|---|---|---|---|---|---|---|
| S1 | ∞ | d0= | −5.373 | | | | |
| R1 | 24.267 | d1= | 0.300 | nd1 | 1.7016 | v1 | 41.14 |
| R2 | 1.814 | d2= | 1.464 | | | | |
| R3 | −95.773 | d3= | 2.072 | nd2 | 1.6607 | v2 | 20.53 |
| R4 | −9.144 | d4= | 0.244 | | | | |
| R5 | 3.164 | d5= | 0.691 | nd3 | 1.6169 | v3 | 63.79 |
| R6 | −4.702 | d6= | 0.496 | | | | |
| R7 | 2.227 | d7= | 0.471 | nd4 | 1.5367 | v4 | 55.99 |
| R8 | −14.372 | d8= | 0.073 | | | | |
| R9 | −5.257 | d9= | 0.324 | nd5 | 1.6607 | v5 | 20.53 |
| R10 | 3.378 | d10= | 0.258 | | | | |
| R11 | 2.781 | d11= | 0.274 | nd6 | 1.5367 | v6 | 55.99 |
| R12 | 2.099 | d12= | 0.487 | | | | |
| R13 | 3.703 | d13= | 0.639 | nd7 | 1.6169 | v7 | 63.79 |
| R14 | 7.193 | d14= | 0.364 | | | | |
| R15 | ∞ | d15= | 0.300 | ndg | 1.5233 | vg | 54.52 |
| R16 | ∞ | d16= | 0.575 | | | | |

Table 10 shows the aspherical data of each lens in the imaging optical lens 50 according to the fifth embodiment of the present disclosure.

TABLE 10

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | −6.5536E+03 | −1.5116E−02 | 6.5217E−04 | 2.7794E−04 | −9.4201E−04 | 6.3097E−04 |
| R4 | −6.7552E+01 | −2.5216E−03 | −7.4129E−03 | 9.1568E−03 | −5.8769E−03 | 2.5682E−03 |
| R5 | −2.2963E+01 | 1.0420E−01 | −1.0078E−01 | 8.8653E−02 | −6.1095E−02 | 2.7755E−02 |
| R6 | 5.9114E+00 | 8.5819E−03 | 4.4902E−03 | −8.4536E−03 | 4.3863E−03 | 7.9028E−04 |
| R7 | −5.3318E+00 | 6.8704E−02 | −2.8569E−04 | 9.9741E−02 | −6.8426E−01 | 1.5899E+00 |
| R8 | −1.2763E+02 | −1.2125E−01 | 4.0790E−01 | −1.3225E+00 | 2.7945E+00 | −3.3280E+00 |
| R9 | 3.1116E+00 | −7.5901E−02 | 5.4205E−01 | −2.1663E+00 | 4.8111E+00 | −6.0963E+00 |
| R10 | 4.0675E+00 | −1.7814E−03 | 2.6562E−01 | −9.0252E−01 | 1.6456E+00 | −1.8631E+00 |
| R11 | −6.7799E+01 | −7.5477E−02 | 4.7896E−02 | −2.5550E−01 | 4.2982E−01 | −4.2809E−01 |
| R12 | −2.6847E+01 | −5.0612E−02 | 5.2490E−02 | −6.6182E−02 | 5.1722E−02 | −2.3826E−02 |
| R13 | −1.2214E+01 | −6.2925E−02 | 3.7447E−02 | −1.1818E−02 | 1.7063E−03 | 3.7378E−04 |
| R14 | 4.0610E+00 | −4.2000E−02 | −5.4164E−04 | 1.0109E−02 | −7.0691E−03 | 2.8608E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | −6.5536E+03 | −1.7012E−04 | 1.7817E−05 | 0.0000E+00 | 0.0000E+00 |
| R4 | −6.7552E+01 | −5.8237E−04 | 4.6025E−05 | 0.0000E+00 | 0.0000E+00 |
| R5 | −2.2963E+01 | −6.9355E−03 | 7.0833E−04 | 0.0000E+00 | 0.0000E+00 |
| R6 | 5.9114E+00 | −1.0005E−03 | 1.9175E−04 | 0.0000E+00 | 0.0000E+00 |
| R7 | −5.3318E+00 | −1.1152E+00 | −3.5149E−02 | 0.0000E+00 | 0.0000E+00 |
| R8 | −1.2763E+02 | 2.2299E+00 | −6.6466E−01 | 0.0000E+00 | 0.0000E+00 |
| R9 | 3.1116E+00 | 4.0941E+00 | −1.1058E+00 | 0.0000E+00 | 0.0000E+00 |
| R10 | 4.0675E+00 | 1.1162E+00 | −2.5161E−01 | 0.0000E+00 | 0.0000E+00 |
| R11 | −6.7799E+01 | 2.0727E−01 | −6.7989E−02 | 0.0000E+00 | 0.0000E+00 |
| R12 | −2.6847E+01 | 4.6094E−03 | 5.5303E−04 | 0.0000E+00 | 0.0000E+00 |
| R13 | −1.2214E+01 | −2.7022E−04 | 6.6048E−05 | −7.9934E−06 | 3.9142E−07 |
| R14 | 4.0610E+00 | −7.3606E−04 | 1.1781E−04 | −1.0665E−05 | 4.1115E−07 |

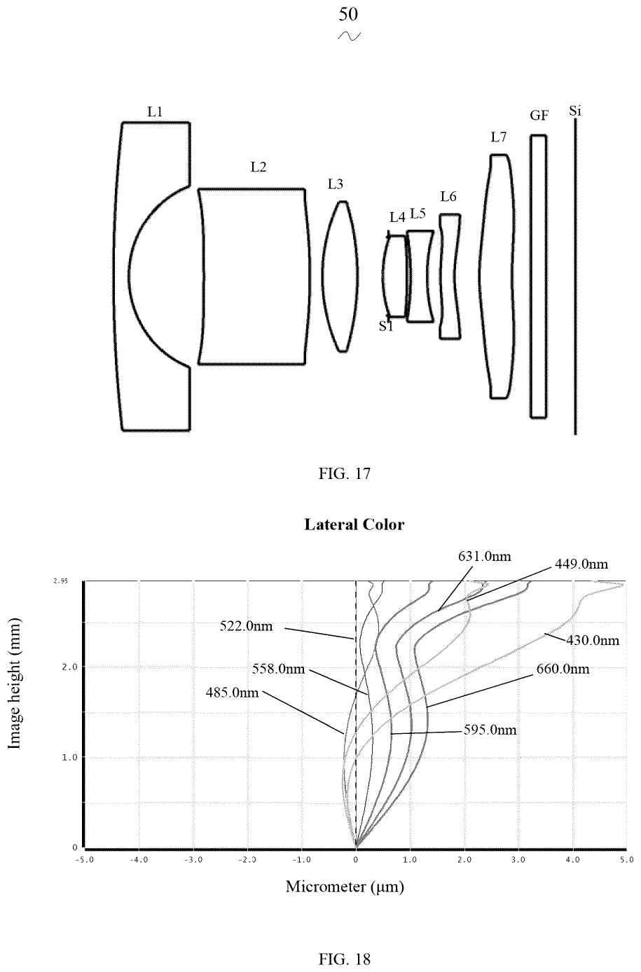

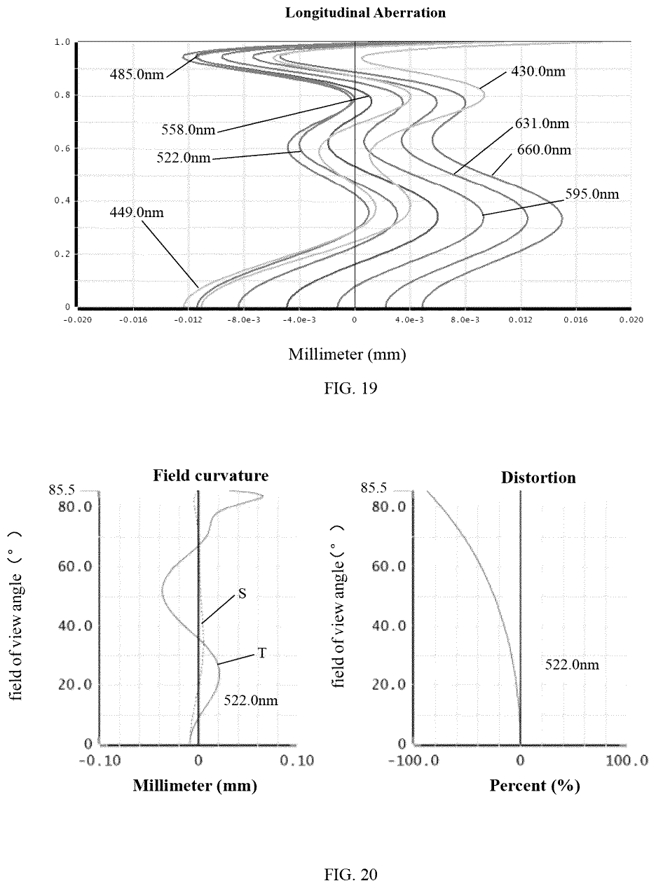

FIG. 18 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 50 of the fifth embodiment. FIG. 19 shows a schematic diagram of the longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 50 of the fifth embodiment. FIG. 20 shows a schematic diagram of the field curvature and distortion of light with a wavelength of 522.0 nm after passing through the imaging optical lens 50 of the fifth embodiment. In FIG. 20, the field curvature S is the field curvature in the sagittal direction, and T is the field curvature in the meridional direction.

In an embodiment, the pupil entering diameter (ENPD) of the imaging optical lens is 2.299 mm, the image height IH of the 1.0 field of view is 2.950 mm, and the field of view angle FOV of the 1.0 field of view is 170.94°, so that the imaging optical lens 50 meets the design requirements of a large aperture, ultra-wide angle and ultra-thinness. Its on-axis and off-axis chromatic aberrations are fully corrected, and it has excellent optical characteristics.

### Sixth Embodiment

The symbol meanings of the sixth embodiment are the same as those of the first embodiment.

FIG. 21 shows the imaging optical lens 60 of the sixth embodiment of the present disclosure.

The sixth lens L6 has positive refractive power.

Tables 11 and 12 show the design data of the imaging optical lens 60 of the sixth embodiment of the present disclosure.

TABLE 11

| | R | d | | nd | | vd | |
|---|---|---|---|---|---|---|---|
| S1 | ∞ | d0= | −5.293 | | | | |
| R1 | 22.018 | d1= | 0.568 | nd1 | 1.8348 | v1 | 42.73 |
| R2 | 1.843 | d2= | 1.398 | | | | |
| R3 | −60.403 | d3= | 1.587 | nd2 | 1.6607 | v2 | 20.53 |
| R4 | −7.629 | d4= | 0.118 | | | | |
| R5 | 3.228 | d5= | 1.038 | nd3 | 1.6169 | v3 | 63.79 |
| R6 | −4.663 | d6= | 0.458 | | | | |
| R7 | 2.218 | d7= | 0.465 | nd4 | 1.5367 | v4 | 55.99 |
| R8 | −21.964 | d8= | 0.070 | | | | |
| R9 | −6.092 | d9= | 0.311 | nd5 | 1.6607 | v5 | 20.53 |
| R10 | 2.946 | d10= | 0.250 | | | | |
| R11 | 2.212 | d11= | 0.358 | nd6 | 1.5367 | v6 | 55.99 |
| R12 | 2.149 | d12= | 0.485 | | | | |
| R13 | 3.441 | d13= | 0.791 | nd7 | 1.6169 | v7 | 63.79 |
| R14 | 5.975 | d14= | 0.363 | | | | |
| R15 | ∞ | d15= | 0.300 | ndg | 1.5233 | vg | 54.52 |
| R16 | ∞ | d16= | 0.569 | | | | |

Table 12 shows the aspherical data of each lens in the imaging optical lens 60 according to the sixth embodiment of the present disclosure.

TABLE 12

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | 1.2039E+03 | −1.5535E−02 | 5.1759E−04 | 4.9887E−04 | −1.0352E−03 | 6.3835E−04 |
| R4 | −7.2821E+01 | −5.4864E−03 | −8.3532E−03 | 8.9925E−03 | −5.8557E−03 | 2.5892E−03 |
| R5 | −2.2268E+01 | 1.0716E−01 | −1.0074E−01 | 8.8720E−02 | −6.1200E−02 | 2.7747E−02 |
| R6 | 5.6683E+00 | 4.3749E−03 | 7.3235E−03 | −8.2331E−03 | 4.1562E−03 | 6.6060E−04 |
| R7 | −4.8828E+00 | 4.3970E−02 | −2.9269E−02 | 1.3225E−01 | −6.1588E−01 | 1.4589E+00 |
| R8 | −9.0594E+02 | −1.3419E−01 | 4.8589E−01 | −1.3662E+00 | 2.7086E+00 | −3.3355E+00 |
| R9 | −2.2120E+01 | −4.8169E−02 | 5.8184E−01 | −2.0522E+00 | 4.4141E+00 | −5.8606E+00 |
| R10 | 4.7180E+00 | 7.1366E−03 | 2.7085E−01 | −8.9944E−01 | 1.6710E+00 | −1.8517E+00 |
| R11 | −2.4446E+01 | −5.1800E−02 | 8.2239E−02 | −2.6129E−01 | 4.1815E−01 | −4.1809E−01 |
| R12 | −1.8309E+01 | −4.8729E−02 | 5.0353E−02 | −6.8451E−02 | 4.9626E−02 | −2.2399E−02 |
| R13 | −6.4926E+00 | −6.1270E−02 | 3.6972E−02 | −1.1845E−02 | 1.7159E−03 | 3.7587E−04 |
| R14 | 3.3289E+00 | −3.7949E−02 | −8.3669E−04 | 1.0130E−02 | −7.0702E−03 | 2.8607E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | 1.2039E+03 | −1.6843E−04 | 1.8231E−05 | 0.0000E+00 | 0.0000E+00 |
| R4 | −7.2821E+01 | −5.7822E−04 | 4.8469E−05 | 0.0000E+00 | 0.0000E+00 |
| R5 | −2.2268E+01 | −6.9222E−03 | 7.1880E−04 | 0.0000E+00 | 0.0000E+00 |
| R6 | 5.6683E+00 | −9.9446E−04 | 2.1774E−04 | 0.0000E+00 | 0.0000E+00 |
| R7 | −4.8828E+00 | −1.5745E+00 | 6.3075E−01 | 0.0000E+00 | 0.0000E+00 |
| R8 | −9.0594E+02 | 2.3453E+00 | −7.3510E−01 | 0.0000E+00 | 0.0000E+00 |
| R9 | −2.2120E+01 | 4.4008E+00 | −1.4491E+00 | 0.0000E+00 | 0.0000E+00 |
| R10 | 4.7180E+00 | 1.0753E+00 | −2.4364E−01 | 0.0000E+00 | 0.0000E+00 |
| R11 | −2.4446E+01 | 2.3204E−01 | −5.0478E−02 | 0.0000E+00 | 0.0000E+00 |
| R12 | −1.8309E+01 | 5.9733E−03 | −6.8571E−04 | 0.0000E+00 | 0.0000E+00 |
| R13 | −6.4926E+00 | −2.6978E−04 | 6.6117E−05 | −7.9911E−06 | 3.8789E−07 |
| R14 | 3.3289E+00 | −7.3605E−04 | 1.1783E−04 | −1.0659E−05 | 4.1286E−07 |

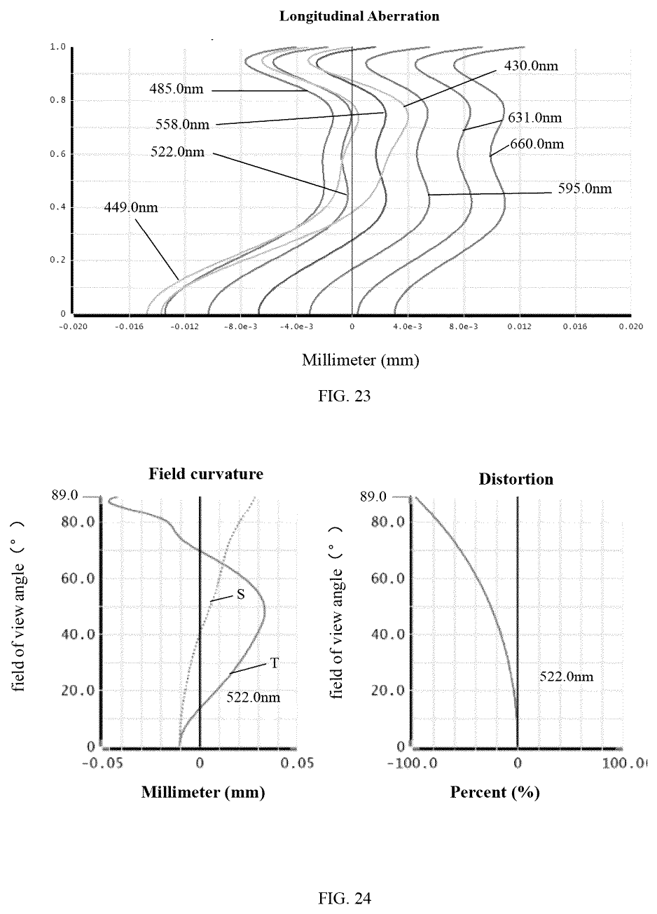

FIG. 22 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 60 of the sixth embodiment. FIG. 23 shows a schematic diagram of the longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 60 of the sixth embodiment. FIG. 24 shows a schematic diagram of the field curvature and distortion of light with a wavelength of 522.0 nm after passing through the imaging optical lens 60 of the sixth embodiment. In FIG. 24, the field curvature S is the field curvature in the sagittal direction, and T is the field curvature in the meridional direction.

In this embodiment, the pupil entering diameter (ENPD) of the imaging optical lens is 2.301 mm, the image height IH of the 1.0 field of view is 2.915 mm, and the field of view angle FOV of the 1.0 field of view is 179.60°, so that the imaging optical lens 60 meets the design requirements of a large aperture, ultra-wide angle and ultra-thinness. Its on-axis and off-axis chromatic aberrations are fully corrected, and it has excellent optical characteristics.

### Seventh Embodiment

The symbol meanings of the seventh embodiment are the same as those of the first embodiment.

FIG. 25 shows the imaging optical lens 70 of the seventh embodiment of the present disclosure.

Tables 13 and 14 show the design data of the imaging optical lens 70 of the seventh embodiment of the present disclosure.

TABLE 13

| | R | d | | nd | | vd | |
|---|---|---|---|---|---|---|---|
| S1 | ∞ | d0= | −6.315 | | | | |
| R1 | 14.772 | d1= | 1.132 | nd1 | 2.0503 | v1 | 37.50 |
| R2 | 1.886 | d2= | 1.293 | | | | |
| R3 | −831.388 | d3= | 2.081 | nd2 | 1.6607 | v2 | 20.53 |
| R4 | −7.027 | d4= | 0.140 | | | | |
| R5 | 3.087 | d5= | 1.088 | nd3 | 1.6169 | v3 | 63.79 |
| R6 | −4.619 | d6= | 0.437 | | | | |
| R7 | 2.226 | d7= | 0.495 | nd4 | 1.5367 | v4 | 55.99 |
| R8 | −8.748 | d8= | 0.075 | | | | |
| R9 | −4.937 | d9= | 0.294 | nd5 | 1.6607 | v5 | 20.53 |
| R10 | 3.018 | d10= | 0.277 | | | | |
| R11 | 2.633 | d11= | 0.335 | nd6 | 1.5367 | v6 | 55.99 |
| R12 | 2.012 | d12= | 0.467 | | | | |
| R13 | 3.104 | d13= | 0.504 | nd7 | 1.6169 | v7 | 63.79 |
| R14 | 5.802 | d14= | 0.382 | | | | |
| R15 | ∞ | d15= | 0.300 | ndg | 1.5233 | vg | 54.52 |
| R16 | ∞ | d16= | 0.588 | | | | |

Table 14 shows the aspherical data of each lens in the imaging optical lens 70 according to the seventh embodiment of the present disclosure.

TABLE 14

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | −1.2251E−02 | 1.3750E−04 | 4.3128E−04 | −1.0635E−03 | 6.4822E−04 | −1.6447E−04 |
| R4 | −5.0634E+01 | −4.1039E−03 | −7.8779E−03 | 8.9625E−03 | −5.9032E−03 | 2.5896E−03 |
| R5 | −2.1054E+01 | 1.0467E−01 | −1.0042E−01 | 8.8746E−02 | −6.1175E−02 | 2.7731E−02 |
| R6 | 5.4299E+00 | 5.2690E−03 | 7.3517E−03 | −8.1742E−03 | 4.2284E−03 | 6.8996E−04 |
| R7 | −4.6187E+00 | 4.9296E−02 | −2.5037E−02 | 1.3383E−01 | −6.2311E−01 | 1.4533E+00 |
| R8 | 1.8713E+01 | −1.5269E−01 | 4.4671E−01 | −1.3623E+00 | 2.7405E+00 | −3.3070E+00 |
| R9 | 1.6831E+01 | −7.6656E−02 | 5.8205E−01 | −2.0714E+00 | 4.4321E+00 | −5.7969E+00 |
| R10 | 4.8225E+00 | 1.1069E−02 | 2.4977E−01 | −9.0460E−01 | 1.6768E+00 | −1.8298E+00 |
| R11 | −4.1476E+01 | −6.6318E−02 | 7.3816E−02 | −2.6522E−01 | 4.1510E−01 | −4.2194E−01 |
| R12 | −1.8587E+01 | −4.5232E−02 | 5.0501E−02 | −6.8813E−02 | 4.9734E−02 | −2.2281E−02 |
| R13 | −6.4523E+00 | −6.3352E−02 | 3.6991E−02 | −1.1861E−02 | 1.7125E−03 | 3.7522E−04 |
| R14 | 2.2074E+00 | −3.6683E−02 | −7.8630E−04 | 1.0061E−02 | −7.0768E−03 | 2.8601E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | −1.2251E−02 | 1.6443E−05 | 0.0000E+00 | 0.0000E+00 | 0.0000E+00 |
| R4 | −5.0634E+01 | −5.7701E−04 | 4.5924E−05 | 0.0000E+00 | 0.0000E+00 |
| R5 | −2.1054E+01 | −6.9334E−03 | 7.1957E−04 | 0.0000E+00 | 0.0000E+00 |
| R6 | 5.4299E+00 | −9.9555E−04 | 2.1815E−04 | 0.0000E+00 | 0.0000E+00 |
| R7 | −4.6187E+00 | −1.5839E+00 | 6.2199E−01 | 0.0000E+00 | 0.0000E+00 |
| R8 | 1.8713E+01 | 2.3127E+00 | −9.1869E−01 | 0.0000E+00 | 0.0000E+00 |
| R9 | 1.6831E+01 | 4.4382E+00 | −1.6772E+00 | 0.0000E+00 | 0.0000E+00 |
| R10 | 4.8225E+00 | 1.0870E+00 | −2.7333E−01 | 0.0000E+00 | 0.0000E+00 |
| R11 | −4.1476E+01 | 2.2913E−01 | −5.1755E−02 | 0.0000E+00 | 0.0000E+00 |
| R12 | −1.8587E+01 | 6.0342E−03 | −7.2691E−04 | 0.0000E+00 | 0.0000E+00 |
| R13 | −6.4523E+00 | −2.6990E−04 | 6.6102E−05 | −7.9889E−06 | 3.9153E−07 |
| R14 | 2.2074E+00 | −7.3606E−04 | 1.1784E−04 | −1.0655E−05 | 4.1344E−07 |

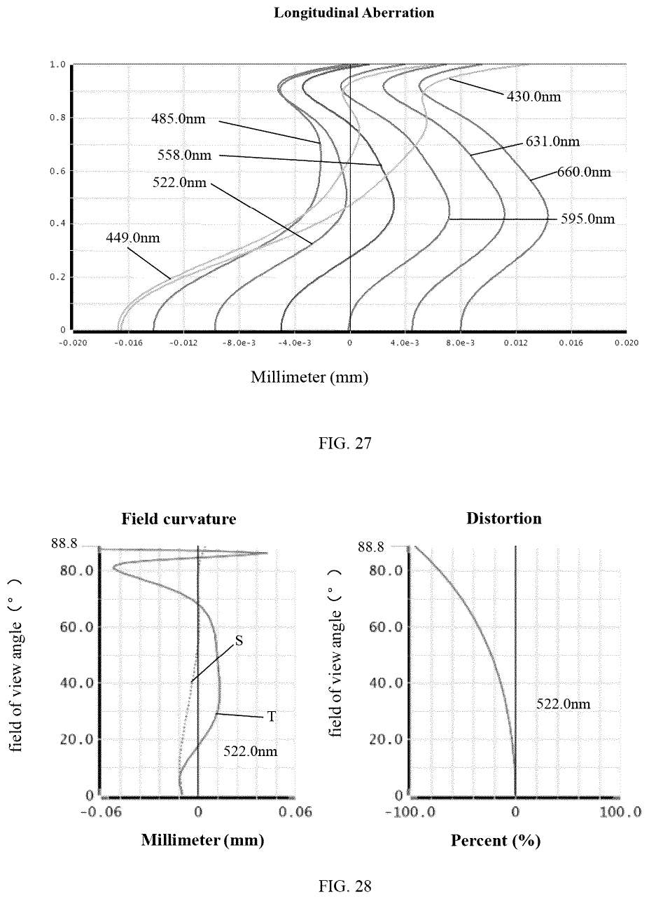

FIG. 26 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 70 of the seventh embodiment. FIG. 27 shows a schematic diagram of the longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 70 of the seventh embodiment. FIG. 28 shows a schematic diagram of the field curvature and distortion of light with a wavelength of 522.0 nm after passing through the imaging optical lens 70 of the seventh embodiment. In FIG. 28, the field curvature S is the field curvature in the sagittal direction, and T is the field curvature in the meridional direction.

In an embodiment, the pupil entering diameter (ENPD) of the imaging optical lens is 2.299 mm, the image height IH of the 1.0 field of view is 3.151 mm, and the field of view angle FOV of the 1.0 field of view is 177.52°, so that the imaging optical lens 70 meets the design requirements of a large aperture, ultra-wide angle and ultra-thinness. Its on-axis and off-axis chromatic aberrations are fully corrected, and it has excellent optical characteristics.

### Comparative Embodiment

The symbol meanings of the comparative embodiment are the same as those of the first embodiment.

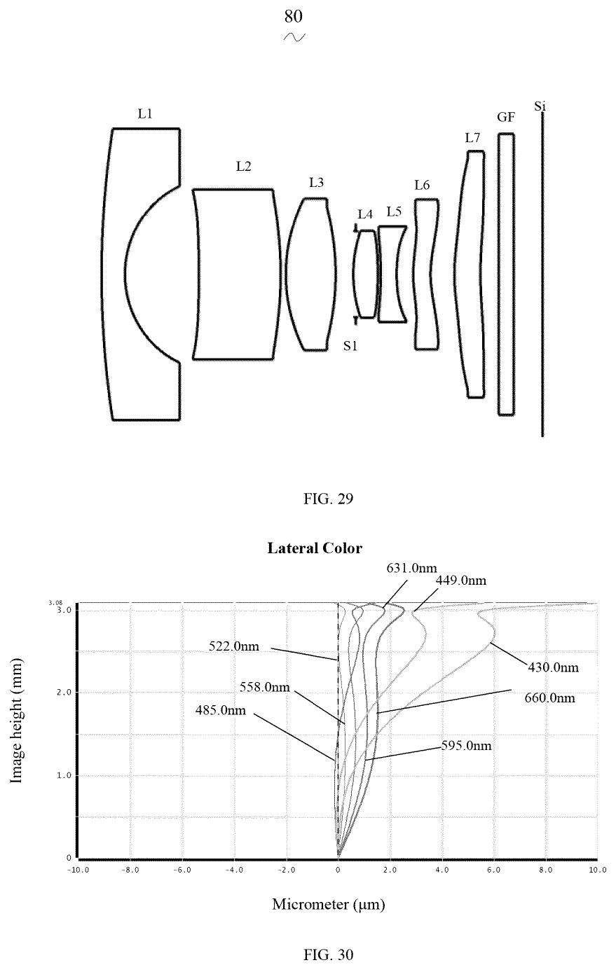

FIG. 29 shows the imaging optical lens 80 of the comparative embodiment of the present disclosure.

Tables 15 and 16 show the design data of the imaging optical lens 80 of the comparative embodiment of the present disclosure.

TABLE 15

| | R | d | | nd | | vd | |
|---|---|---|---|---|---|---|---|
| S1 | ∞ | d0= | −5.026 | | | | |
| R1 | 17.489 | d1= | 0.461 | nd1 | 1.8348 | v1 | 42.73 |
| R2 | 1.841 | d2= | 1.459 | | | | |
| R3 | −28.018 | d3= | 1.616 | nd2 | 1.6607 | v2 | 20.53 |
| R4 | −6.189 | d4= | 0.102 | | | | |
| R5 | 3.213 | d5= | 0.989 | nd3 | 1.6169 | v3 | 63.79 |
| R6 | −4.665 | d6= | 0.349 | | | | |
| R7 | 2.407 | d7= | 0.482 | nd4 | 1.5367 | v4 | 55.99 |
| R8 | −8.706 | d8= | 0.060 | | | | |
| R9 | −6.344 | d9= | 0.315 | nd5 | 1.6607 | v5 | 20.53 |
| R10 | 2.998 | d10= | 0.326 | | | | |
| R11 | 2.143 | d11= | 0.342 | nd6 | 1.5367 | v6 | 55.99 |
| R12 | 1.760 | d12= | 0.471 | | | | |
| R13 | 3.247 | d13= | 0.514 | nd7 | 1.6169 | v7 | 63.79 |
| R14 | 6.356 | d14= | 0.361 | | | | |
| R15 | ∞ | d15= | 0.300 | ndg | 1.5233 | vg | 54.52 |
| R16 | ∞ | d16= | 0.567 | | | | |

Table 16 shows the aspherical data of each lens in the imaging optical lens 80 according to the comparative embodiment of the present disclosure.

TABLE 16

| | Conic coefficient | Aspheric coefficient | | | | |
|---|---|---|---|---|---|---|
| | k | A4 | A6 | A8 | A10 | A12 |
| R1 | / | / | / | / | / | / |
| R2 | / | / | / | / | / | / |
| R3 | −9.8067E+02 | −1.4670E−02 | 4.4757E−04 | 4.5538E−04 | −1.0665E−03 | 6.3747E−04 |
| R4 | −6.6380E+01 | −4.0795E−03 | −8.2730E−03 | 8.8195E−03 | −5.9039E−03 | 2.5823E−03 |
| R5 | −1.8821E+01 | 1.0556E−01 | −1.0175E−01 | 8.8673E−02 | −6.1191E−02 | 2.7771E−02 |
| R6 | 5.3965E+00 | 5.3126E−03 | 7.8581E−03 | −8.2022E−03 | 4.1945E−03 | 6.6162E−04 |
| R7 | −5.6010E+00 | 4.7133E−02 | −1.4929E−02 | 1.3179E−01 | −6.3363E−01 | 1.4332E+00 |
| R8 | −5.1437E+01 | −1.4763E−01 | 4.7592E−01 | −1.3884E+00 | 2.6784E+00 | −3.3576E+00 |
| R9 | −5.3330E+00 | −5.6714E−02 | 5.6610E−01 | −2.0503E+00 | 4.4208E+00 | −5.8784E+00 |
| R10 | 5.4570E+00 | 1.8309E−02 | 2.7504E−01 | −8.9496E−01 | 1.6855E+00 | −1.8276E+00 |
| R11 | −3.6149E+01 | −6.1660E−02 | 7.8159E−02 | −2.6150E−01 | 4.1912E−01 | −4.1721E−01 |
| R12 | −1.8221E+01 | −4.4875E−02 | 5.3041E−02 | −6.7519E−02 | 4.9659E−02 | −2.2609E−02 |
| R13 | −1.5818E+01 | −6.1876E−02 | 3.7149E−02 | −1.1821E−02 | 1.7151E−03 | 3.7474E−04 |
| R14 | 3.2093E+00 | −3.6409E−02 | −1.0769E−03 | 1.0090E−02 | −7.0745E−03 | 2.8605E−03 |

| | Conic coefficient | Aspheric coefficient | | | |
|---|---|---|---|---|---|
| | k | A14 | A16 | A18 | A20 |
| R1 | / | / | / | / | / |
| R2 | / | / | / | / | / |
| R3 | −9.8067E+02 | −1.6613E−04 | 1.9674E−05 | 0.0000E+00 | 0.0000E+00 |
| R4 | −6.6380E+01 | −5.7541E−04 | 4.9535E−05 | 0.0000E+00 | 0.0000E+00 |
| R5 | −1.8821E+01 | −6.9194E−03 | 7.1779E−04 | 0.0000E+00 | 0.0000E+00 |
| R6 | 5.3965E+00 | −9.8011E−04 | 2.1155E−04 | 0.0000E+00 | 0.0000E+00 |
| R7 | −5.6010E+00 | −1.5916E+00 | 6.4294E−01 | 0.0000E+00 | 0.0000E+00 |
| R8 | −5.1437E+01 | 2.3371E+00 | −7.7469E−01 | 0.0000E+00 | 0.0000E+00 |
| R9 | −5.3330E+00 | 4.3503E+00 | −1.4791E+00 | 0.0000E+00 | 0.0000E+00 |
| R10 | 5.4570E+00 | 1.0778E+00 | −2.9497E−01 | 0.0000E+00 | 0.0000E+00 |
| R11 | −3.6149E+01 | 2.3241E−01 | −5.1189E−02 | 0.0000E+00 | 0.0000E+00 |
| R12 | −1.8221E+01 | 5.9114E−03 | −6.7236E−04 | 0.0000E+00 | 0.0000E+00 |
| R13 | −1.5818E+01 | −2.7007E−04 | 6.6079E−05 | −7.9870E−06 | 3.9253E−07 |
| R14 | 3.2093E+00 | −7.3599E−04 | 1.1785E−04 | −1.0656E−05 | 4.1298E−07 |

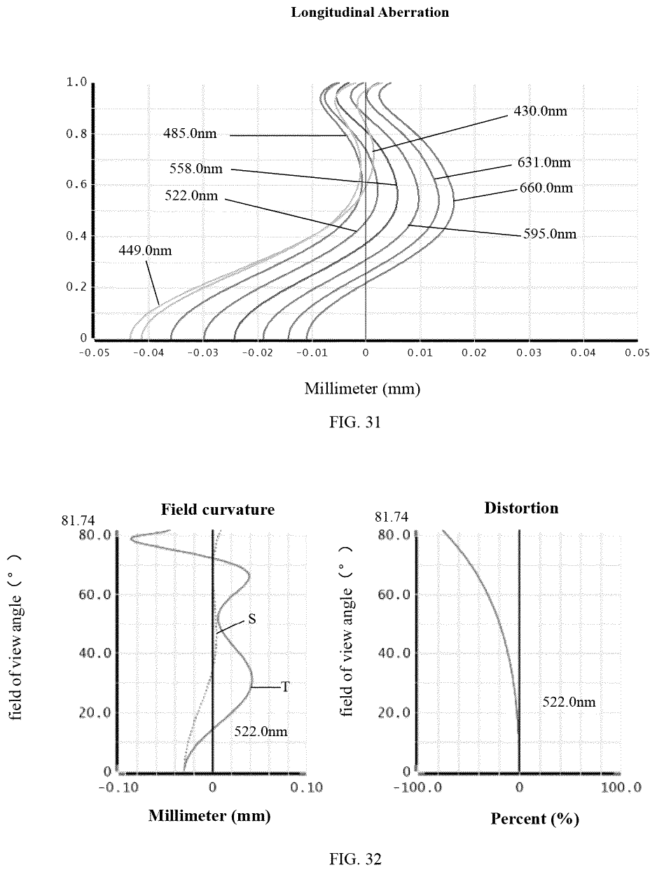

FIG. 30 shows a schematic diagram of the lateral color of light with wavelengths of 430.0 nm, 449.0 nm, 485.0 nm, 522.0 nm, 558.0 nm, 595.0 nm, 631.0 nm, and 660.0 nm after passing through the imaging optical lens 80 of the comparative embodiment. FIG. 31 shows a schematic diagram of the longitudinal aberration of light with wavelengths of 430.0 nm, 449.0 nm, 485.0 nm, 522.0 nm, 558.0 nm, 595.0 nm, 631.0 nm, and 660.0 nm after passing through the imaging optical lens 10 of the comparative embodiment. FIG. 32 shows a schematic diagram of the field curvature and distortion of light with a wavelength of 522.0 nm after passing through the imaging optical lens 80 of the comparative embodiment. In FIG. 32, the field curvature S is the field curvature in the sagittal direction, and T is the field curvature in the meridional direction.

Table 17 lists the numerical values corresponding to each relationship formula in the present embodiments according to the above conditions. Obviously, the imaging optical lens 80 of the comparative embodiment does not satisfy the above relationship formula 100.00≤(FOV*f)/IH≤120.00.

In the comparative embodiment, the pupil entering diameter (ENPD) of the imaging optical lens is 2.299 mm, the image height IH of the 1.0 field of view is 3.082 mm, and the field of view angle FOV of the 1.0 field of view is 163.47°. The imaging optical lens 80 does not meet the design requirements of ultra-wide angle and ultra-thinness.

TABLE 17

| | Parameters & Relationship formula | | | | | | | |
|---|---|---|---|---|---|---|---|---|
| | First | Second | Third | Fourth | Fifth | Sixth | Seventh | comparative |
| | Embodiment | Embodiment | Embodiment | Embodiment | Embodiment | Embodiment | Embodiment | Embodiment |
| f | 2.035 | 2.054 | 1.914 | 2.094 | 1.915 | 1.947 | 1.777 | 1.835 |
| f1 | −2.452 | −2.455 | −2.508 | −2.346 | −2.783 | −2.418 | −2.133 | −2.475 |
| f2 | 11.878 | 11.955 | 12.618 | 12.037 | 14.863 | 12.807 | 10.509 | 11.452 |
| f3 | 3.237 | 3.242 | 3.213 | 3.227 | 3.153 | 3.235 | 3.151 | 3.219 |
| f4 | 3.604 | 3.617 | 3.520 | 3.653 | 3.603 | 3.752 | 3.335 | 3.542 |
| f5 | −2.963 | −3.028 | −2.994 | −3.035 | −3.008 | −2.908 | −2.740 | −2.982 |
| f6 | −26.656 | −13.780 | −22.949 | −17.580 | −18.453 | 139.063 | −19.478 | −26.494 |
| f7 | 11.376 | 8.170 | 11.479 | 10.178 | 11.487 | 11.675 | 10.031 | 10.055 |
| f12 | −4.176 | −4.13 | −4.155 | −3.895 | −4.459 | −3.897 | −3.789 | −4.469 |
| f7/f | 5.59 | 4.00 | 6.00 | 4.86 | 6.00 | 6.00 | 5.65 | 5.48 |
| (FOV*f)/IH | 108.44 | 110.35 | 110.33 | 109.42 | 111.02 | 119.90 | 100.10 | 97.36 |
| (R11 + R12)/ | 8.57 | 3.91 | 7.79 | 7.69 | 7.16 | 69.93 | 7.48 | 10.19 |
| (R11 − R12) | | | | | | | | |
| n1 | 1.84 | 1.84 | 1.84 | 1.84 | 1.70 | 1.84 | 2.05 | 1.84 |
| BF/TTL | 0.15 | 0.15 | 0.10 | 0.25 | 0.14 | 0.14 | 0.13 | 0.14 |
| d3/d5 | 1.63 | 1.48 | 1.61 | 1.54 | 3.00 | 1.53 | 1.91 | 1.63 |
| FNO | 2.30 | 2.30 | 2.30 | 2.30 | 2.30 | 2.30 | 2.30 | 2.30 |
| TTL | 9.00 | 9.14 | 10.22 | 8.79 | 9.03 | 9.13 | 9.89 | 8.71 |

Those of ordinary skill in the art will understand that the above embodiments are specific implement, and in practical applications, there may be various changes in form and detail without departing from the spirit and scope of the present disclosure.

What is claimed is:

1. An imaging optical lens, comprising:
seven lenses that are sequentially arranged from an object-side to an image-side as follows:
a first lens with negative refractive power;
a second lens with positive refractive power;
a third lens with positive refractive power;
a fourth lens with positive refractive power;
a fifth lens with negative refractive power;
a sixth lens with refractive power; and
a seventh lens with positive refractive power; and
wherein:
f represents a focal length of the imaging optical lens;
f7 represents a focal length of the seven lens;
FOV represents the field of view angle of the 1.0 field of view of the imaging optical lens;
IH represents a full field-of-view (1.0H) image-height;
R11 represents a central curvature radius of the object-side surface of the sixth lens;
R12 represents a central curvature radius of the image-side surface of the sixth lens;
and the imaging optical lens satisfies the following relationships:
$$3.95 \leq f 7 / f \leq 6. ;$$
$$100. \leq ( FOV * f ) / IH \leq 120. ;$$
$$3.5 \leq ( R 11 + R 12 ) / ( R 11 - R 12 ) \leq 70. .$$

2. The imaging optical lens of claim 1, wherein a refractive index of the first lens is n1, and the imaging optical lens satisfies the following relationship:
$$1.7 \leq n 1 \leq 2.1 .$$

3. The imaging optical lens of claim 1, wherein BF represents an on-axis distance from the image-side surface of the seventh lens to the image surface, TTL represents a total optical length of the imaging optical lens, and the imaging optical lens satisfies the following relationship:
$$0.1 \leq BF / TTL \leq 0.25 .$$

4. The imaging optical lens of claim 1, wherein d3 represents an on-axis thickness of the second lens, d5 represents an on-axis thickness of the third lens, and the imaging optical lens satisfies the following relationship:
$$1.4 \leq d 3 / d 5 \leq 3. .$$

5. The imaging optical lens of claim 1, wherein an object-side surface of the first lens is convex in a paraxial region, and an image-side surface of the first lens is concave in a paraxial region;
f1 represents a focal length of the first lens, R1 represents a central curvature radius of the object-side surface of the first lens, R2 represents a central curvature radius of the image-side surface of the first lens, d1 represents an on-axis thickness of the first lens, and the imaging optical lens satisfies the following relationships:
$$- 1.5 \leq f 1 / f \leq - 1.1 ;$$
$$1.1 \leq ( R 1 + R 2 ) / ( R 1 - R 2 ) \leq 1.35 ;$$
$$0.03 \leq d 1 / TTL \leq 0.17 .$$

6. The imaging optical lens of claim 1, wherein an object-side surface of the second lens is concave in a paraxial region, and an image-side surface of the second lens is convex in a paraxial region;
f2 represents a focal length of the second lens, R3 represents a central curvature radius of the object-side surface of the second lens, R4 represents a central curvature radius of the image-side surface of the second lens, d3 represents an on-axis thickness of the second lens, and the imaging optical lens satisfies the following relationships:
$$5.6 \leq f 2 / f \leq 7.8 ;$$
$$0.99 \leq ( R 3 + R 4 ) / ( R 3 - R 4 ) \leq 1.33 ;$$
$$0.15 \leq d 3 / TTL \leq 0.24 .$$

7. The imaging optical lens of claim 1, wherein an object-side surface of the second lens is convex in a paraxial region, and an image-side surface of the second lens is convex in a paraxial region;
f3 represents a focal length of the third lens, R5 represents a central curvature radius of the object-side surface of the third lens, R6 represents a central curvature radius of the image-side surface of the third lens, d5 represents an on-axis thickness of the third lens, and the imaging optical lens satisfies the following relationships:
$$1.52 \leq f 3 / f \leq 1.8 ;$$
$$- 0.21 \leq ( R 5 + R 6 ) / ( R 5 - R 6 ) \leq - 0.17 ;$$
$$0.06 \leq d 5 / TTL \leq 0.13 .$$

8. The imaging optical lens of claim 1, wherein an object-side surface of the fourth lens is convex in a paraxial region, an image-side surface of the fourth lens is convex in a paraxial region;
f4 represents a focal length of the fourth lens, R7 represents a central curvature radius of the object-side surface of the fourth lens, R8 represents a central curvature radius of the image-side surface of the fourth lens, d7 represents an on-axis thickness of the fourth lens, and the imaging optical lens satisfies the following relationships:
$$1.7 \leq f 4 / f \leq 1.96 ;$$
$$- 0.85 \leq ( R 7 + R 8 ) / ( R 7 - R 8 ) \leq - 0.5 ;$$
$$0.04 \leq d 7 / TTL \leq 0.06 .$$

9. The imaging optical lens of claim 1, wherein an object-side surface of the fifth lens is concave in a paraxial region, and an image-side surface of the fifth lens is concave in a paraxial region;
f5 represents a focal length of the fifth lens, R9 represents a central curvature radius of the object-side surface of the fifth lens, R10 represents a central curvature radius of the image-side surface of the fifth lens, d9 represents an on-axis thickness of the fifth lens, and the imaging optical lens satisfies the following relationships:
$$- 1.6 \leq f 5 / f \leq - 1.4 ;$$
$$0.2 \leq ( R 9 + R 10 ) / ( R 9 - R 10 ) \leq 0.42 ;$$
$$0.02 \leq d 9 / TTL \leq 0.04 .$$

10. The imaging optical lens of claim 1, wherein an object-side surface of the sixth lens is convex in a paraxial region, and an image-side surface of the sixth lens is concave in a paraxial region;
f6 represents a focal length of the sixth lens; d11 represents an on-axis thickness of the sixth lens, and the imaging optical lens satisfies the following relationship:
$$- 13.5 \leq f 6 / f \leq 72. ;$$
$$0.02 \leq d 11 / TTL \leq 0.05 .$$

11. The imaging optical lens of claim 1, wherein an object-side surface of the seventh lens is convex in a paraxial region, and an image-side surface of the seventh lens is concave in a paraxial region;
R13 represents a central curvature radius of the object-side surface of the seventh lens, R14 represents a central curvature radius of the image-side surface of the seventh lens, d13 represents an on-axis thickness of the seventh lens, and the imaging optical lens satisfies the following relationship:
$$- 3.8 \leq ( R 13 + R 14 ) / ( R 13 - R 14 ) \leq - 2.2 ;$$
$$0.02 \leq d 13 / TTL \leq 0.09 .$$

12. The imaging optical lens of claim 1, wherein the first lens, the third lens, and the seventh lens are made of glass; the second lens, the fourth lens, the fifth lens, and the sixth lens are made of plastic.

13. The imaging optical lens of claim 1, wherein the f-number (FNO) of the imaging optical lens is less than or equal to 2.30; the Field of view angle (FOV) of the 1.0 field of view of the imaging optical lens is greater than or equal to 154.67°.
